(19) United States
(12) Patent Application Publication
(10) Pub. No.: US 2010/0296403 A1
(43) Pub. Date: Nov. 25, 2010

(54) Predictable Performance Optimization of Wireless Networks

(75) Inventors: Lili Qiu, Austin, TX (US); Yin Zhang, Austin, TX (US); Yi Li, Fu Zhou (CN)

Correspondence Address: Lili Qiu, 10404 Skyflower Drive, Austin, TX, 78759, US

(73) Assignees: Lili Qiu, Austin, TX (US); Yin Zhang, Austin, TX (US); Yi Li, Mountain View, CA (US)

(21) Appl. No.: 12/753,881

(22) Filed: Apr. 4, 2010

Related U.S. Application Data
(60) Provisional application No. 61/166,936, filed on Apr. 6, 2009.

(51) Int. Cl. H04W 24/00

(52) U.S. Cl. 370/252

(57) ABSTRACT

Methods are described for optimizing wireless networks in a predictable way, i.e., the performance optimized is achievable in a real network. The methods consist of two main components: (i) a novel model that captures the relationship between network topology, wireless interference, traffic demand, and MAC-induced dependencies to accurately predict the throughput of individual flows in the wireless network, and (ii) a model-driven optimization that uses this model to optimize the network for a given performance objective.

### CROSS-REFERENCE TO RELATED APPLICATIONS

The present application claims the benefit of Qiu et al., U.S. Provisional Patent Application No. 61/166,936 entitled, “Predictable Performance Optimization of Wireless Networks”, filed on Apr. 6, 2009, which is hereby incorporated by reference in its entirety.

### STATEMENT REGARDING FEDERALLY SPONSORED RESEARCH OR DEVELOPMENT

This invention was made with government support under CNS0546755 awarded by National Science Foundation. The government has certain rights in the invention.

### FIELD OF THE INVENTION

Embodiments of the invention relate, generally, to wireless networks and, in particular, to providing predictable performance optimization of wireless networks.

### BACKGROUND OF THE INVENTION

Wireless networks are becoming increasingly ubiquitous in the form of WLANs, city-wide meshes, and sensor networks. But extracting predictable performance from these networks today is notoriously hard. A single new flow can lead to a disproportionate decline in network performance. Attempts to increase network performance, for instance by adding relay nodes to shorten link distances, can end up reducing performance. This is in sharp contrast to wireline network management, where network operators have many effective techniques to predict and improve performance.

A need exists for optimization techniques for wireless networks that enable a prediction of the resulting performance at the level of individual flows. As motivating examples, consider three basic capabilities that are not available today and likely cannot even be approximated easily for real networks. First, network operators should be able to predict if the network can support the current or a planned traffic demand. Second, they should be able to perform “what-if analysis” to predict the impact of configuration changes such as addition of new flows or routing changes. Finally, they should be able to predict safe sending rates of various flows based on policy and path capacity.

The final capability above is especially important for good performance. Without appropriate rate-limiting, network throughput can decline sharply when flows send more than what the path can support. This degradation can be severe even in a simple setting of a single flow traversing two links. End-to-end congestion control, e.g., using TCP, while helpful, is not sufficient to prevent this pathological behavior.

### BRIEF SUMMARY OF THE INVENTION

Embodiments described herein provide, among other things, a novel model-driven approach for optimizing wireless networks. One focus is on static, 802.11-based, multi-hop networks, though the general methodology described herein can be applied to other scenarios. A cornerstone of the approach of embodiments described herein is a new model that captures the complex interference, traffic, and MAC-induced dependencies in the network. These dependencies are some of the underlying causes of unpredictable behavior. Capturing them accurately and in a way that subsequently allows for optimization is a fundamental challenge in fulfilling the goals described herein.

Despite much work on interference and MAC modeling, none of the existing models for multi-hop networks fulfills the needs described above. Many existing models make simplifying assumptions about signal propagation (See, P. Gupta and P. R. Kumar, “The capacity of wireless networks,” IEEE Transactions on Information Theory, 46(2), March 2000 (Gupta et al.)), traffic (See M. Garetto, J. Shi, and E. Knightly, “Modeling media access in embedded two-flow topologies of multi-hop wireless networks,” In Proc. of ACM MOBICOM, August-September 2005 (Garetto et al.), C. Reis, R. Mahajan, M. Rodrig, D. Wetherall, and J. Zahorjan, “Measurement-based models of delivery and interference,” In Proc. of ACM SIGCOMM, 2006 (Reis et al.), Y. Gao, J. Lui, and D. M. Chiu, “Determining the end-to-end throughput capacity in multi-hop networks: Methodology and applications,” In Proc. of ACM SIGMETRICS, June 2006 (Goa et al.), and L. Qiu, Y. Zhang, F. Wang, M. K. Han, and R. Mahajan, “A general model of wireless interference,” In Proc. of ACM MOBICOM, September 2007 (Qiu et al.)), topology (See G. Bianchi, “Performance analysis of the IEEE 802.11 distributed coordination function,” In IEEE Journal on Selected Areas in Communications, March 2000 (Bianchi), A. Kumar, E. Altman, D. Miorandi, and M. Goyal, “New insights from a fixed point analysis of single cell IEEE 802.11 wireless LANs,” In Proc. of IEEE INFOCOM, March 2005 (Kumar et al.), Goa et al., and Garetto et al.), or the MAC layer (See K. Jain, J. Padhye, V. N. Padmanabhan, and L. Qiu, “Impact of interference on multi-hop wireless network performance,” In Proc. ACM MOBICOM, September 2003 (Jain et al.)). These assumptions often do not hold for real networks (See D. Kotz, C. Newport, R. S. Gray, J. Liu, Y. Yuan, and C. Elliott, “Experimental evaluation of wireless simulation assumptions,” In Proc. of the ACM/IEEE International Symposium on Modeling, Analysis and Simulation of Wireless and Mobile Systems (MSWiM), October 2004 (Kotz et al.)). Many models also have high complexity and may require an exponential number of constraints (See Jain et al.) or states (See Qiu et al.).

The model of embodiments described herein strikes a balance between simplicity and realism. Based on easily collected measurements from the network itself, it characterizes the set of feasible network configurations and traffic assignments using very few constraints. Given links that are actively sending traffic, the model has O(n²) complexity and only O(n) constraints. Despite its simplicity, the model can handle real-world complexities such as hidden terminals, non-uniform traffic, multi-hop flows, and non-binary interference.

Embodiments described herein further include development of optimization algorithms that compute rate-limits for flows according to the specified performance objective. These algorithms take flow demands as input and use the model of embodiments described herein as a basic building block. The two performance objectives considered herein are maximizing fairness and maximizing total network throughput. Such goal-driven and precise optimization for multi-hop wireless networks was not possible before.

Evaluation using a multi-hop wireless testbed and simulation experiments shows that the approach of embodiments described herein is highly effective. Across a range of topology and traffic configurations, it is able to accurately approximate the throughput that the network yields. It rarely under-predicts, and for 80% of the cases, its estimate is within 20% of the actual throughput. When maximizing fairness using the methods described herein, close to perfect fairness amongst flows for both UDP and TCP traffic can be achieved. When maximizing throughput, the methods of embodiments described herein can improve network throughput by 100-200% for UDP-based traffic and 10-50% for TCP-based traffic. Interestingly, experiments have also shown that that the exact choice of routing protocol is not important for good performance; what matters instead is that flows be rate-limited per the desired performance goal.

In summary, embodiments described herein provide, among other things, the following contributions. First, they show that rate-limiting flows to levels that the network can safely support is critical for good performance; otherwise, network throughput can sharply degrade even in very simple settings (Section 1). Second, a novel approach to optimize multi-hop wireless networks (Section 2) has been developed. The approach of embodiments described herein can include a simple yet realistic model of network throughput under interference- and MAC-induced dependencies (Section 3). Algorithms can thereafter be provided that use this model to optimize for fairness amongst flows and for throughput (Section 4).

The approach described herein can thereafter be evaluated using extensive testbed and simulation based experiments (Sections 5-8). The evaluation shows that it can accurately predict network throughput, achieve close to perfect fairness, and substantially improve network throughput.

### BRIEF DESCRIPTION OF THE SEVERAL VIEWS OF THE DRAWINGS

Having thus described embodiments of the invention in general terms, reference will now be made to the accompanying drawings, which are not necessarily drawn to scale, and wherein:

FIGS. 1A-1C illustrate the importance of rate feedback in accordance with embodiments described herein;

FIGS. 2A-2B provide confirmation of the importance of rate control in accordance with embodiments described herein;

FIG. 3A illustrates the topology for a TCP example described herein;

FIG. 3B is a table providing the model constants and variables in accordance with embodiments described herein;

FIG. 4 outlines the algorithm performed for link throughput feasibility testing in accordance with embodiments described herein;

FIG. 5 outlines the algorithm performed for fair rate allocation in accordance with embodiments described herein;

FIG. 6 outlines the algorithm performed for maximizing total throughput in accordance with embodiments described herein;

FIGS. 7A & 7B illustrate the amount of traffic sent to an AP in 10-second intervals at a WiFi hotspot and at a SIGCOMM 2004, respectively in accordance with embodiments described herein;

FIG. 8 illustrates the CDF of link loss rate in testbed in accordance with embodiments described herein;

FIG. 9 illustrates the throughput prediction accuracy in simulation of a model for grid topologies, saturated UDP traffic, and RST/CTS=OFF, in accordance with embodiments described herein;

FIG. 10 illustrates the throughput prediction accuracy in simulation of the CG-based model for grid topologies, saturated UDP demands, and without RTS/CTS in accordance with embodiments described herein;

FIGS. 11A-11D illustrate the throughput prediction accuracy in simulation of a model for various configurations in accordance with embodiments described herein;

FIGS. 12A & 12B illustrate throughput prediction accuracy of a model in testbed with RTS/CTS=OFF for saturated UDP demands and saturated TCP demands, respectively, in accordance with embodiments described herein;

FIGS. 13A & 13B illustrate throughput prediction accuracy in testbed using CG-model for RTS/CTS=OFF and for saturated UDP and TCP traffic, respectively, in accordance with embodiments described herein;

FIGS. 14A & 14B illustrate fairness comparison in testbed for RTS/CTS=OFF and saturated UDP and TCP traffic, respectively, in accordance with embodiments described herein;

FIGS. 15A-15D illustrate fairness improvement in simulation for difference configurations, in accordance with embodiments described herein;

FIGS. 16A & 16B illustrate throughput improvement in testbed with rate limiting for saturated UDP and random UDP demand, respectively, in accordance with embodiments described herein;

FIGS. 17A & 17B illustrate TCP throughput improvement in testbed with rate limiting for saturated TCP and random TCP demand, respectively, in accordance with embodiments described herein;

FIGS. 18A-18D illustrate throughput improvement in simulation with rate limiting for UDP traffic for various configurations in accordance with embodiments described herein;

FIGS. 19A & 19B illustrate throughput improvement in simulation with rate limiting for saturated TCP demand, grid topology and RTS/CTS=OFF and RTS/CTS=ON, respectively, in accordance with embodiments described herein;

FIGS. 20A & 20B illustrate throughput in testbed of four routing methods with and without rate limiting for saturated UDP and TCP demand, respectively, in accordance with embodiments described herein;

FIGS. 21A-21D illustrate throughput in simulation of four routing methods—HOP, ETX, MIC and CG—with and without rate limiting;

FIGS. 22A and 22B are block diagrams of types of systems that would benefit from embodiments described herein; and

FIG. 23 is a schematic block diagram of an entity capable of operating as a multi-hop wireless network device in accordance with embodiments described herein

### DETAILED DESCRIPTION OF THE INVENTION

Embodiments of the present invention now will be described more fully hereinafter with reference to the accompanying drawings, in which some, but not all embodiments of the inventions are shown. Indeed, embodiments of the invention may be embodied in many different forms and should not be construed as limited to the embodiments set forth herein; rather, these embodiments are provided so that this disclosure will satisfy applicable legal requirements. Like numbers refer to like elements throughout.

In general, embodiments of the present invention provide an improvement by, among other things, providing a novel approach to optimize the performance of IEEE 802.11-based multi-hop wireless networks. A unique feature of the approach of embodiments described herein is that it enables an accurate prediction of the resulting throughput of individual flows. At its heart lies a simple yet realistic model of the network that captures interference, traffic, and MAC-induced dependencies. Unless properly accounted for, these dependencies lead to unpredictable behaviors. For instance, it can be shown that even a simple network of two links with one flow is vulnerable to severe performance degradation. Algorithms can thereafter be designed that build on this model to optimize the network for fairness and throughput. Given traffic demands as input, these algorithms can compute rates at which individual flows must send to meet the objective. Evaluation using a multi-hop wireless testbed as well as simulations shows that the approach of embodiments described herein is very effective. When optimizing for fairness, the methods of embodiments described herein can result in close to perfect fairness. When optimizing for throughput, they lead to 100-200% improvement for UDP traffic and 10-50% for TCP traffic.

### 1. Motivation:

One goal of the work of embodiments described herein is to enable systematic optimization of multi-hop wireless networks, whose resulting performance can be predicted at the level of individual flows. To illustrate, consider the following examples of abilities that an operator may want but does not have today. These abilities are all pretty basic when it comes to managing networks and are available in wired networks today.

The first is the ability to determine whether the current or a planned traffic matrix can be supported by the network. This can be considered an essential capability for network planning as it tells the operators when to add more resources, e.g., additional radios on orthogonal channels or directional antennae to reduce interference.

Second, an operator may want the ability to perform “what if” analysis on various configuration changes, to judge the impact of a change on the network. Such an analysis should be able to answer questions such as the following. What if a new flow is added between two nodes? What if a particular link or node is removed from the network? What if a particular routing change is implemented?

Finally, an operator may further want the ability to compute and cap the sending rate of individual flows based on network polices and path capacity. This again can be considered especially important in wireless networks. A flow that sends more impacts not only those flows that it shares links with (as is the case in wired networks), but also many other flows in the vicinity due to interference. More importantly, as is shown below, a flow that sends more than what the path supports can cause a sharp decline in throughput. This decline is reminiscent of congestion collapse in wired networks.

As is discussed is more detail below, the optimization strategy of embodiments described herein relies on computing flow rates such that the specified performance objective is met. It can be shown that limiting flow rates can be considered essential to obtaining good performance from the network. Without it, severe performance degradation can occur.

### UDP Traffic

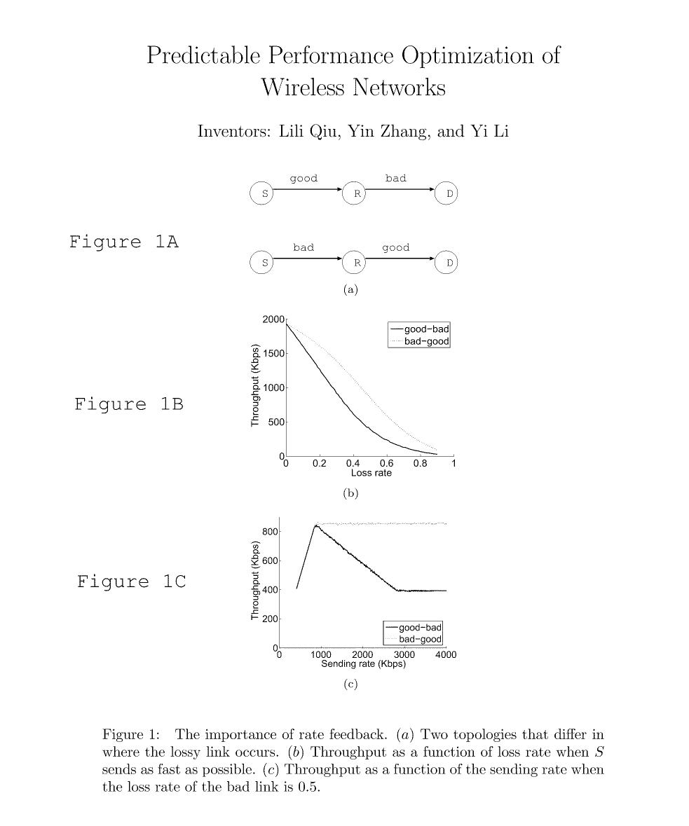

This point can be illustrated using the two simple topologies in FIG. 1A. Both have one reliable (“good”) link and one lossy (“bad”) link but the order of the two links is different. Using QualNet (See The Qualnet simulator from Scalable Networks Inc., http://www.scalable-networks.com/), the case of S sending 512-byte UDP packets to D as fast as possible can be simulated. Unless otherwise specified, experiments described herein use 802.11a and 6 Mbps MAC bit rate.

FIG. 1B shows that the throughput of the two topologies as a function of loss rate on the bad link is very different. At a loss rate of 0.5, the throughput of the good-bad topology is less than half of the bad-good topology.

One reason for this disparity is the following. For a successful reception in the good-bad topology, S needs to transmit a packet to R only once, but R has to transmit to D more than once. Since the 802.11 MAC allocates the medium fairly among S and R under saturated demands, the incoming traffic at R is more than the outgoing traffic, and many packets sent by S are eventually dropped at R due to queue overflow. These wasted transmissions of S compete with those from R and reduce the throughput of the good-bad topology. Such wastage does not exist in the bad-good topology because R can send all incoming traffic.

This problem cannot be solved by RTS/CTS because both transmitters can hear each other and there is no hidden terminal. Moreover, simply changing the MAC allocation policy will not fix the problem in the general case because the bottleneck can be multiple hops away from the source.

The wastage in the good-bad topology can lead to a sharp decline in throughput as the sending rate is increased. FIG. 1C plots the throughput of the two topologies as S increases its sending rate. The loss rate is configured to 0.5. In the good-bad topology, increasing the sending rate beyond a threshold sharply degrades throughput. This threshold represents the sending rate of S at which R can relay all received packets. Beyond it, R cannot keep up as the medium is increasingly occupied by the transmissions from S that are eventually dropped. The throughput stabilizes when the medium usage of R decreases to half.

The graph also shows that the two topologies have the same maximum capacity, but in the good-bad case, it can be achieved only if S is limited to the threshold sending rate. However, none of the current routing protocols give rate feedback. Moreover they cannot even distinguish between these two paths. The path quality as measured by current protocols will be the same for both topologies.

This sharp decline in throughput is reminiscent of congestion collapse in the Internet. But it is unique in that it is caused by a single flow over a very simple topology. Known examples of congestion collapse in wired networks (See S. Floyd and K. Fall, “Promoting the use of end-to-end congestion control in the Internet,” IEEE/ACM Transactions on Networking, 7(4), 1999) involve more complex configurations. A key difference is that the capacity of the bottleneck link in a wired network is not impacted by other links, but in wireless networks interference reduces bottleneck capacity when other links are active.

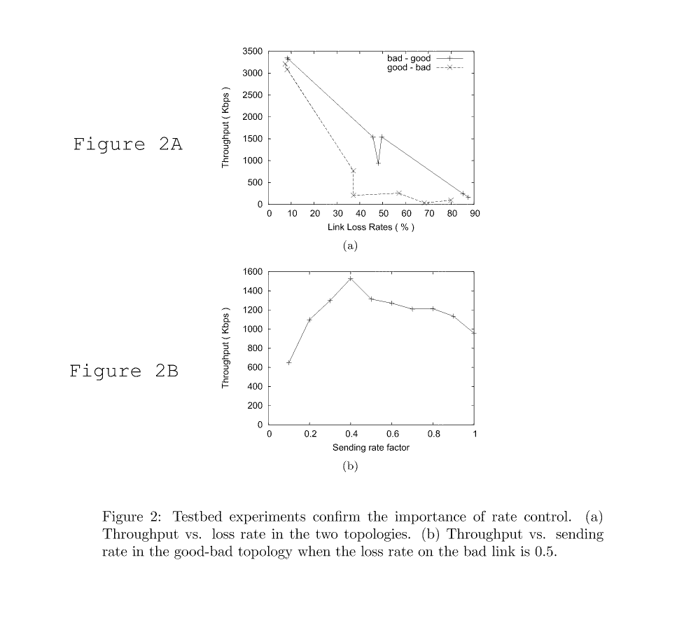

FIG. 2 confirms that this pathology can be replicated in the more realistic testbed setting as well. Different loss rates in the testbed are emulated by changing the distance between the machines and varying layers of foil around the wireless cards. FIG. 2A shows that the two topologies perform differently when S sends as fast as possible. FIG. 2B shows the sudden throughput decline in the good-bad topology when the bad link has roughly 50% loss. The -axis in this graph denotes the fraction of the fastest possible sending rate. When the sending rate factor is 1, the source sends packets back-to-back. The curve is not as smooth because the loss rate in the testbed cannot be precisely controlled. Overall, these results confirm the ill-effects of not controlling sending rates.

### TCP Traffic

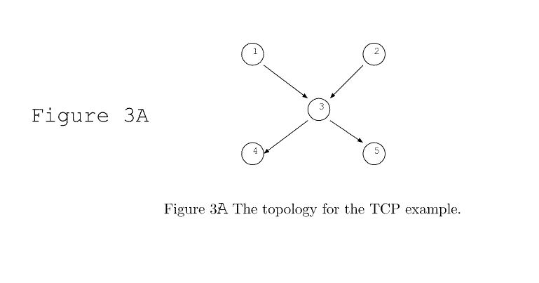

Similar problems can occur with TCP as well because TCP's built-in rate control and congestion response are not well-suited for the wireless environment. Consider a star topology shown in FIG. 3A, where all links are reliable. There are two competing TCP flows 1→5 and 2→4. Performance degradation can be found due to overload when the central node cannot relay all the traffic sent by its neighbors. With 1024-byte packets, in the absence of additional rate limiting, the two flows get 0.805 Mbps and 0.740 Mbps, respectively. In comparison, if their application-layer sending rates are limited using the optimization framework of embodiments described herein (see Section 4) and constrain the burstiness of TCP by limiting the TCP sender buffer to 2 packets, the two flows get 1.066 Mbps and 1.064 Mbps, respectively, which translates to 37.9% increase in total throughput. With 512-byte packets, rate limiting results in 20.8% increase in total throughput. This example demonstrates that TCP is unable to appropriately set its rate to where it can maximize throughput. This is likely because TCP's aggressive bandwidth probing makes the flows stabilize at a loss rate higher than the loss rate under maximum throughput (See Z. Fu, H. Luo, P. Zerfos, S. Lu, L. Zhang, and M. Gerla, “The impact of multihop wireless channel on TCP performance,” IEEE Trans. on Mobile Computing, March 2005).

### 2. Overall Approach:

The previous section showed that dependencies introduced by interference and MAC can lead to significant performance problems in wireless networks. Thus, any optimization strategy must be able to model and predict these effects. Embodiments described herein develop a model-driven optimization approach. Embodiments focus on IEEE 802.11-based networks, though the framework described herein would be useful for other MAC protocols as well.

The model of embodiments described herein can exhibit the following two properties. First, it can provide an accurate and compact characterization of the feasible solution space, which can then be incorporated in an optimization procedure to find a high-performance configuration. Second, it can strike a balance between fidelity, generality, and tractability, which can be considered crucial for optimization to be effective and efficient.

In particular, according to embodiments described herein, a model is provided that has low complexity. Given n links that are actively sending traffic, the model of embodiments described herein has O(n²) complexity. It can consist of O(n) constraints that capture the inter-dependency between throughput, transmission probabilities, and packet loss rates of different links. These constraints collectively characterize the set of network configurations and traffic assignments that can be achieved in 802.11 networks. In contrast, many existing models are complex and may require an exponential number of state variables (See Qiu et al.) or constraints (See Jain et al.) in the worst case. Despite its simplicity, the model of embodiments described herein can also be considered general and realistic. According to one embodiment, the model can be based on easily collected measurements from the underlying network and is thus more accurate than abstract models of RF propagation such as those based on distance. The model of one embodiment can also deal with real-world complexities such as hidden terminals, non-uniform traffic, multi-hop flows, and non-binary interference. In contrast, existing interference models often impose restrictive assumptions about signal propagation (See Gupta et al.), traffic (See Garetto et al., Reis et al., Goa et al., and Qiu et al.), topology (See Bianchi, Kumar et al., Goa et al. and Garetto et al.), or the MAC layer (See Jain et al.). These assumptions rarely hold for real networks (See Kotz et al.).

According to one embodiment, the model can be used in several ways for wireless network optimization. First, it can be used to answer “what-if” questions, such as testing whether desired end-to-end throughput can be achieved (see Section 4.1). It can also predict the performance under different network configurations, such as the impact of enabling or disabling RTS/CTS. Second, in conjunction with an efficient search mechanism, the model can be directly applied to optimize certain performance objectives when there are only a small number of control parameters. This is the case for fair rate allocation, which has a single optimization parameter (see Section 4.2). Third, the constraints of the model of one embodiment can be linearized and incorporated into an optimization procedure. This is the case for network throughput maximization, which has many parameters (see Section 4.3).

### 3. Model:

In this section, a model is developed in accordance with an embodiment of the present invention for IEEE 802.11 that can be used for model-driven optimization. The model can be described in terms of network “links,” which are unidirectional, and each link has a unique source-destination pair of nodes.

### 3.1 Basic Model of 802.11 DCF

According to one embodiment a basic model of 802.11 DCF can first be developed for the base case in which all flows are one-hop UDP flows and RTS/CTS is disabled. The model can then be extended to support RTS/CTS, multi-hop flows, and different transport protocols in Section 3.2.

### Assumptions:

According to one embodiment, the model makes key assumptions. First, it assumes pairwise interference, i.e., the interference relationship between two links is independent of activities on other links. Previous works show that pairwise interference is good approximation in real networks (See J. Padhye, S. Agarwal, V. N. Padmanabhan, L. Qiu, A. Rao, and B. Zill, “Estimation of link interference in static multi-hop wireless networks,” In Proc. of Internet Measurement Conference (IMC), October 2005 (Padhye et al.), and D. Niculescu, “Interference map for 802.11 networks,” In Proc. of Internet Measurement Conference (IMC), November 2007). Second, it assumes that different types of loss (e.g., collision loss and inherent wireless medium loss) are independent.

While these assumptions do not always hold in practice, they are a reasonable approximation to the reality. Under these assumptions, it is not necessary to model intricate interactions among different links, e.g., links A and B interfere only when links C and D are active. As a result, the model of embodiments described herein can become significantly simplified—it has O(n²) complexity and only O(n) constraints, where n is the number of active links. In Section 6, simulations and testbed experiments are used to show that the model of embodiments described herein can be quite accurate despite these simplifications.

### Constraints:

Following Bianchi's approach (See Bianchi), time can be divided into variable-length slots (VLS) for each link. When the link senses a clear channel and either has no data to send or its backoff counter has not yet reached 0, the current VLS lasts for a regular slot time Tₛₗₒₜ. When the link senses a clear channel, has data to send, and its backoff counter is 0, it sends a packet and the current VLS lasts for the entire packet transmission. When the link senses a busy channel, the current VLS lasts until the channel is clear for a DIFS duration.

The model of embodiments described herein can consist of four types of constraints that capture the inter-dependency between throughput, transmission probability, packet loss rate, and VLS duration of different links. These constraints are described below. FIG. 3B summarizes the notations, where constants are in upper case and variables are in lower case. To ensure consistency, slot time Tₛₗₒₜ is used as the common unit for the calculation of time in the model of embodiments described herein.

### Throughput Constraint

The throughput constraint relates throughput to transmission probability, packet loss rate, and VLS duration. Let τᵢ be the probability for Link i to start a packet transmission during a VLS. Let pᵢ be the loss probability for such a packet transmission. Let μᵢ be the expected duration of a VLS at Link i. Let EP, be the expected payload transmission time at Link i. Then, the throughput for Link i, denoted by gᵢ, is simply the fraction of time that it spends on successful payload transmissions:

$${g}_{i} = \frac{{EP}_{i} \times {τ}_{i} \times ( 1 - {p}_{i} )}{{μ}_{i}} \qquad ( 1 )$$

### VLS Duration Constraint

The VLS duration constraint relates the expected VLS duration p, to transmission probability τⱼ:

$${μ}_{i} = {T}_{slot} + {\sum }_{j} [ ( {W}_{ij} - {T}_{slot} ) \times {τ}_{j} ] \qquad ( 2 )$$

where Wᵢⱼ (j≠i) is the expected amount of time for Link i to wait due to carrier-sense for Link j to complete a transmission, and Wᵢᵢ is the expected amount of time for Link i to complete a transmission.

Wᵢⱼ and Wᵢᵢ can be estimated as follows. Let Lⱼ^{dat} be the inherent DATA loss rate on Link j. Let Dᵢⱼ^{src} and Dᵢⱼ^{dst} be the probabilities for Link i to carrier sense Link j's source and destination, respectively. Let Tᵢ^{dat} be the expected duration of DATA transmission on Link j, which consists of a DIFS duration, a MAC preamble duration, the transmission time for the payload and packet headers. Let Tⱼ^{ack} be the expected duration of ACK transmission on Link j, which consists of a SIFS duration, a MAC preamble duration, and the transmission time for an ACK. Wᵢⱼ and Wᵢᵢ can then be estimated as:

Wᵢⱼ=Dᵢⱼ^{src}×Tⱼ^{dat}+Dᵢⱼ^{dst}×Tⱼ^{ack}×(1−Lⱼ^{dat})

Wᵢᵢ=Tᵢ^{dat}+Tᵢ^{ack}×(1−Lᵢ^{dat})

Two simplifications have been made above. The effect of collision loss on VLS duration has been ignored and only the inherent DATA loss rate Lⱼ^{dat} has been used to estimate the probability for a DATA transmission to succeed. This simplification turns Wᵢⱼ and Wᵢᵢ into constants instead of variables at the expense of slightly overestimating the expected VLS duration. The effect of NAV on Wᵢⱼ is also ignored, i.e., it is assumed that Link i waits for Link j's ACK only if it is transmitted. In reality, if Link i successfully receives Link j's DATA, it would wait even if no ACK is transmitted because of the NAV value embedded in Link j's DATA. The latter simplification may result in slight underestimation of the expected VLS duration, but the effect is small because ACK is typically much shorter than DATA.

### Loss Rate Constraint

The loss rate constraint relates packet loss rate to transmission probability. To compute packet loss rate pᵢ, one can model both inherent medium loss and collision loss. Following Qiu et al collision loss can be further distinguished between: (i) synchronous loss that occurs when the two senders can carrier sense each other; and (ii) asynchronous loss that occurs when at least one sender cannot carrier sense the other.

Assuming independence among different types of loss caused by different links, the packet success probability of Link i is

$$1 - {p}_{i} = ( 1 - {L}_{i}^{dat} ) \times ( 1 - {L}_{i}^{ack} ) \times {\prod }_{j \neq i} [ ( 1 - {l}_{ij}^{sync} ) \times ( 1 - {l}_{ij}^{async} ) ]$$

where Lᵢ^{dat} and Lᵢ^{ack} are the inherent loss rate of DATA and ACK on Link i; lᵢⱼ^{sync} and lᵢⱼ^{asyn} are synchronous and asynchronous collision loss on Link i caused by Link j, which can be modeled as follows.

The synchronous collision loss rate is given by lᵢⱼ^{sync}=Sᵢⱼτⱼ, where τⱼ captures the probability for Link j to start transmitting at the same time as Link i, and is the probability for a packet on Link i to get lost due to collision with a packet on Link j conditioned on the fact that the two packet transmissions start at the same time. Note that a packet is lost when either its DATA or ACK is lost. So Sᵢⱼ combines the conditional loss rates of DATA and ACK.

The asynchronous collision loss rate is given by lᵢⱼ^{async}=1−(1−θⱼ)^{A}^{ᵢⱼ}, where

$${θ}_{j} = \frac{{τ}_{j}}{{μ}_{j}}$$

is the probability for Link j to start transmitting at a random time instant. It is obtained by normalizing tⱼ by the expected VLS duration μⱼ. Aᵢⱼ is the asynchronous collision loss exponent defined as

$${A}_{ij} = {\int }_{- {T}_{μ}}^{{T}_{μ}} {C}_{ij} ( x ) d x$$

where T_{μ} is the maximum duration of a packet transmission, Cᵢⱼ(x) is the conditional probability for a packet on Link i to get lost due to collision with a packet on Link j when the start times of the two packet transmissions differ by offset x. Thus, Cᵢⱼ(0)=Sᵢⱼ. To understand the intuition behind the definition of Aᵢⱼ, imagine that time is divided into bins of fixed width Δx. For a given time bin at offset x, the probability for Link j to start a transmission in it is θjΔx. Similar to the analysis of synchronous collision loss, the probability for Link j's packet to cause collision loss in Link i's packet at offset x is given by Cᵢⱼ(x)θⱼΔx. The probability for Link i's packet to succeed despite collision with Link j's packet can therefore be approximated as 1−Cᵢⱼ(x)θΔx≈(1−θⱼ)^{C}^{ᵢⱼ}^{(x)Δx}. Assuming independent collision loss for different offsets, the total asynchronous collision loss probability for Link i can therefore be approximated by

$$1 - {\prod }_{x ∈ [ - {T}_{μ} , {T}_{μ} ]} {( 1 - {θ}_{j} )}^{{C}_{ij} ( x ) Δ x} = 1 - {( 1 - {θ}_{j} )}^{{\sum }_{x ∈ [ - {T}_{μ} , {T}_{μ} ]} {C}_{ij} ( x ) Δ x}$$

whose limit becomes

$$1 - {( 1 - θ )}^{{\int }_{- {T}_{μ}}^{{T}_{μ}} {C}_{ij} ( x ) d x} = 1 - {( 1 - {θ}_{j} )}^{{A}_{ij}}$$

as Δx tends to 0.

Putting it all together, it can be possible to model packet loss rate pᵢ as a function of transmission probability τⱼ and

$${θ}_{j} = \frac{{τ}_{j}}{{μ}_{j}} \text{:}$$

$${p}_{i} = 1 - ( 1 - {L}_{i}^{dat} ) \times ( 1 - {L}_{i}^{ack} ) \times {\prod }_{j \neq i} [ ( 1 - {S}_{ij} {τ}_{j} ) \times {( 1 - {θ}_{j} )}^{{A}_{ij}} ] \qquad ( 3 )$$

### Feasibility Constraint

With 802.11 DCF, the transmission probability τᵢ is feasible if and only if it is C

$${τ}_{i} \leq \frac{2}{2 + CW ( {p}_{i} )} , \qquad ( 4 )$$

where

$$CW ( {p}_{i} ) = {CW}_{min} + {p}_{i} \times ( 1 + {CW}_{min} ) \times {\sum }_{k = 0}^{M - 1} {( 2 {p}_{i} )}^{k}$$

is the expected contention window size under packet loss rate pᵢ, CWₘᵢₙ is the minimum contention window size in slots. For 802.11a,

$${CW}_{min} = 15 , M = {log}_{2} ( \frac{{CW}_{max} + 1}{{CW}_{min} + 1} ) , and {CW}_{max} = 1023.$$

### 3.2 Extensions of the Basic Model

According to one embodiment, the basic model above can be extended to support RTS/CTS, multi-hop flows, and TCP traffic. In the interest of space, only the key ideas are presented below.

### RTS/CTS

To support RTS/CTS, two modifications can be made. First, in the VLS constraint (Eq. 2), constants Wᵢⱼ and Wᵢᵢ are updated to account for the additional delay introduced by RTS and CTS. Second, the loss rate constraint (Eq. 3) is extended to incorporate the inherent RTS and CTS loss rates, Lᵢ^{rts} and Lᵢ^{ets}, and the additional collision losses involving RTS and CTS.

Multi-hop flows

Given routing information, it may then be possible to convert multi-hop UDP flows into one-hop UDP flows. Specifically, let x=<x_{d}>_{m×1} be the vector of end-to-end flow rates. Let R=[R_{id}]_{n×m} be the n×m routing matrix, where R_{id} is the fraction of Flow d that traverses Link i. Let g=<gᵢ>_{n×1} be the vector of link loads. Then, you have

g=R·x (5)

Note that the conversion above applies only when the end-to-end flow rates are feasible. If the end-to-end flow rates are infeasible, a multi-hop flow may result in more traffic on hops near the origin, which cannot be carried forward by the subsequent hops. Restricting to only feasible flow rates is not a problem for model-driven optimization because you only need to consider feasible flow rate assignments.

### TCP Traffic

Finally, when TCP is used as the transport layer protocol, it may also be necessary to take into account the TCP acknowledgment traffic. To convert multi-hop TCP demands into one-hop link demands, the routing matrix R in Eq. 5 can be replaced with a new routing matrix R_{TCP} that combines the forward and reverse direction of TCP connections. Specifically, let R_{fwd} and Rᵣₑᵥ be the routing matrix for the forward and reverse direction of TCP connections, respectively. One can define

R_{TCP}=R_{fwd}+α×Rᵣₑᵥ, (6)

where the α coefficient reflects the size and frequency of TCP acknowledgments. Assuming that TCP acknowledgments contain no payload, without TCP delayed acknowledgments, simply set

$$α = \frac{H}{H + EP} ,$$

where H is the total size of IP and TCP headers, and EP is the expected payload size. With TCP delayed acknowledgments enabled, set

$$α = 0.5 \times \frac{H}{H + EP} .$$

### 3.3 Model Initialization

To apply the model of embodiments described herein, the constants in FIG. 3B may need to be initialized. A few of the key constant are: (i) inherent loss rates Lᵢ^{dat}, Lᵢ^{ack}, Lᵢ^{rts}, and Lᵢ^{ets}; (ii) carrier sense probabilities Dᵢⱼ^{src} and Dᵢⱼ^{dst}; and (iii) collision loss parameters Sᵢⱼ and Aᵢⱼ. For simplicity, these parameters can be estimated by conducting pairwise broadcast measurements (See Padhye et al.), but the model of embodiments described herein can just as easily use the inputs inferred by more scalable approaches (See Qiu et al.).

First let one Node a send alone. All the other nodes record the receiving rates from α. Dividing the receiving rates by a's sending rate yields the inherent loss rates for all links from α. ACK, RTS, and CTS are smaller than the smallest UDP packets. Approximate their inherent loss rate by broadcasting UDP packets with -byte payload.

Next have two nodes a and b send simultaneously. By comparing a's sending rates when both a and b are sending, it can be possible to estimate the probability for a to carrier sense b. Specifically, it can be possible to show that a's broadcast packet sending rate when b is transmitting is given by

$$\frac{{τ}_{a}}{{T}_{slot} + ( {T}_{a} - {T}_{slot} ) \times {τ}_{a} + ( {T}_{b} - {T}_{slot} ) \times {τ}_{b} \times {D}_{ab}} ,$$

where

$${τ}_{a} = {τ}_{b} = \frac{2}{2 + {CW}_{min}}$$

for saturated broadcast traffic, D_{ab} is the probability for a to carrier sense b, Tₐ and T_{b} are the packet transmission times including preamble and header. So the single unknown D_{ab} can be easily computed based on the measured sending rate of a.

To estimate Sᵢⱼ and Aᵢⱼ, the conditional loss probability Cᵢⱼ(x) for different offsets x between the start times of the two packet transmissions on Links i and j can be evaluated. Based on carrier sense probabilities, the probability for a broadcast transmission on Link i to overlap with a broadcast transmission on Link j can be estimated. This overlapping probability can be denoted by Oᵢⱼ^{bcast} and can be computed by applying the two-sender broadcast model of Qiu et al. The conditional loss probability for Link i when transmissions on the two links overlap can be denoted by Cᵢⱼ^{bcast}. It is computed based on

Rᵢⱼ^{bcast}=(1−Lᵢ^{bcast})×(1−Oᵢⱼ^{cast}×Cᵢⱼ^{bcast})

Above, Lᵢ^{bcast} is the inherent loss rate on Link i, and is the broadcast receive rate for Link i when both links are sending. Finally, Cᵢⱼ (x) can be computed by combining the collision loss rate for all steps of a packet transmission, i.e., DATA, ACK, and if applicable, RTS, CTS.

### 4. Model-Driven Optimization:

In this section, the model of embodiments described herein is applied to optimize wireless performance. According to one embodiment, the overall optimization strategy is to compute sending rates for all flows based on their demands, the network topology, and the optimization objective. An algorithm is first described to test whether a given flow rate assignment is achievable in Section 4.1. Maximizing fairness is then considered in Section 4.2 and maximizing total throughput is considered in Section 4.3.

### 4.1 Flow Throughput Feasibility Testing

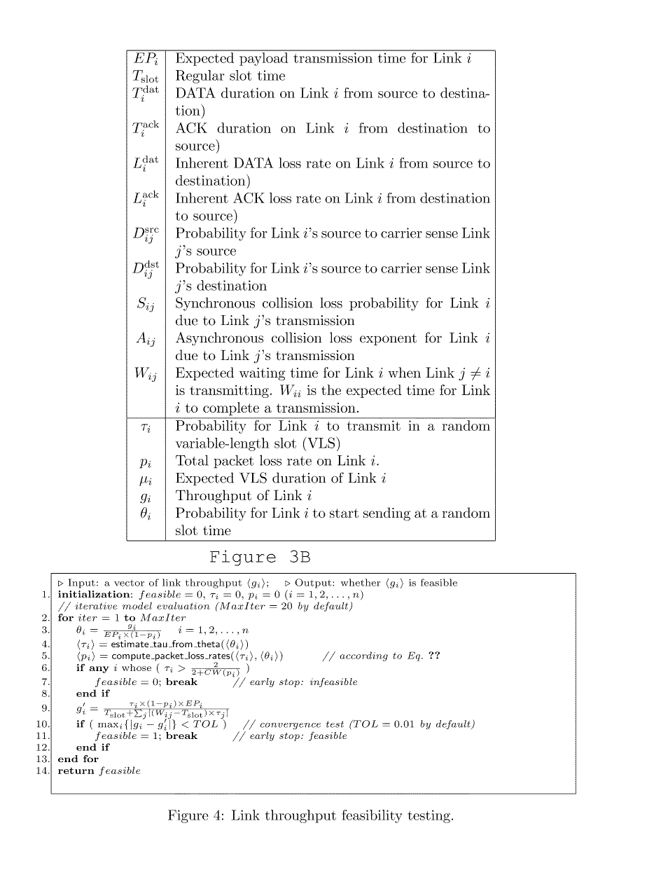

One goal of embodiments described herein is to test whether a given set of link throughput gᵢ's is achievable. One challenge is that there is strong inter-dependency between the transmission probability and the loss rate of different links. The transmission probability of a Link i, τᵢ, depends on the transmission probability of the other links, which in turn depends on τᵢ. To address the inter-dependency, an iterative procedure can be used to jointly estimate the transmission probabilities and loss rates. The collision loss and transmission probabilities can be initialized at all links to be 0. Link transmission probabilities and loss rates can then be iteratively updated based on the other links' transmission probabilities and loss rates derived in the previous iteration. FIG. 4 outlines the algorithm of one embodiment described herein.

To estimate <τᵢ> given <θᵢ> (Line 4 in FIG. 4), one can note that

$${θ}_{i} = \frac{{τ}_{i}}{{μ}_{i}} = \frac{{τ}_{i}}{{T}_{slot} + {\sum }_{j} [ ( {W}_{ij} - {T}_{slot} ) \times {τ}_{j}} .$$

Therefore, one can estimate <τᵢ> by solving the following system of linear equations

$$\{ {T}_{slot} + {\sum }_{j} [ ( {W}_{ij} - {T}_{slot} ) \times {τ}_{j} ] \} \times {θ}_{i} = {τ}_{i} , i = 1 , 2 , … , n \qquad ( 7 )$$

The iterative procedure continues until the number of iterations reaches a threshold, or the throughput values no longer change significantly, or a feasibility constraint (Eq. 4) is violated. In one embodiment the number of iterations can be bound, for example to twenty, which works well in the experiments described herein.

### 4.2 Fair Rate Allocation

Given the feasibility test for link throughputs, it can be used as a basic block for achieving weighted max-min fair rate allocation. This allocation takes routing and traffic demand matrices as input.

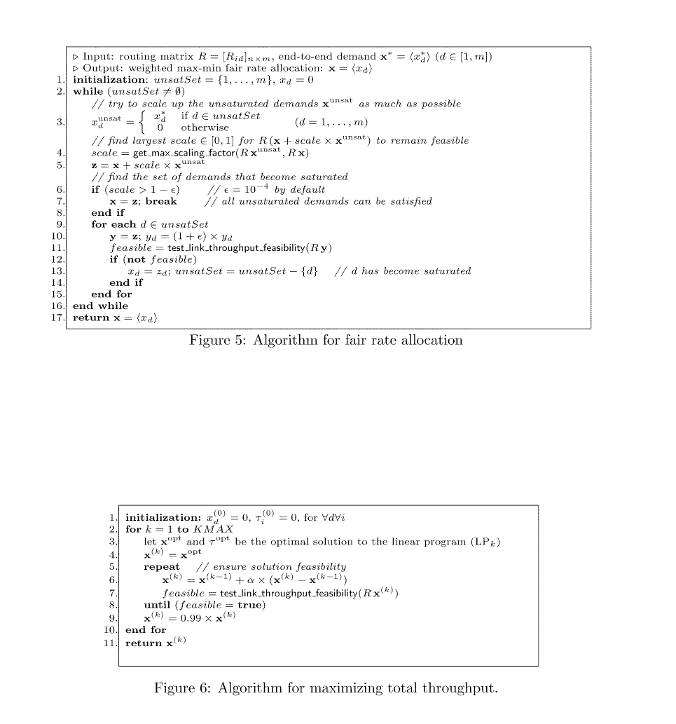

FIG. 5 outlines the algorithm, which is effectively based on iterative water-filling. Let x*=<x_{d}*> be the end-to-end demand. Le R=[R_{id}]_{n×m} be the routing matrix, where R_{id} is the fraction of Flow d that traverses Link i. The vector of link loads is given by R·x. Initially, the algorithm marks all demands as unsaturated. In each iteration, the algorithm tries to scale up all the unsaturated demands as much as possible until at least one unsaturated flow is saturated, i.e., it cannot be scaled up further without violating a feasibility constraint. The maximum scaling factor scale E [0,1] is found efficiently through bisection search in the subroutine get_max_scaling_factor(g^{unsat}, g^{sat}) (Line 4 in FIG. 5). The iteration continues to scale up the remaining unsaturated demands until all demands are saturated.

### 4.3 Total Throughput Maximization

According to one embodiment, the network for maximum total throughput can be optimized by formulating a non-linear optimization problem. This problem can be solved by linearizing the non-linear constraints and solving a series of linear programs.

As before, let x*=<x_{d}*> be the end-to-end demand and R=[R_{id}]_{n×m} be the routing matrix. Let Rᵢ be the i-th row vector of R. The problem of maximizing total end-to-end throughput can be cast into the following non-linear optimization problem (NLP).

$$maximize {\sum }_{d} {x}_{d} \\ subject to \{ \begin{matrix}{R}_{i} x \leq {F}_{i} ( τ ) & ∀ i \\ {G}_{i} ( τ ) \leq 0 & ∀ i \\ 0 \leq {x}_{d} \leq {x}_{d}^{*} & ∀ d \\ 0 \leq {τ}_{i} \leq 1 & ∀ i\end{matrix} \qquad ( NLP )$$

where

$${F}_{i} ( τ ) = \frac{{EP}_{i} \times {τ}_{i} \times ( 1 - {p}_{i} )}{{T}_{slot} + {\sum }_{j} ( {W}_{ij} - {T}_{slot} ) \times {τ}_{j}}$$

and

$${G}_{i} ( τ ) = {τ}_{i} - \frac{2}{2 + CW ( {p}_{i} )} .$$

Therefore, constraints Rᵢx≦Fᵢ(τ) encode the linear relationship between end-to-end throughput and link throughput; constraints Gᵢ(τ)≦0 encode the feasibility constraint (Eq. 4).

The NLP above can be solved through iterative linear programming, as shown in FIG. 6. In each iteration, the non-linear constraints in the NLP can be linearized using their first-order approximation. Specifically, let x^{(k-1)} and τ^{(k-1)} be the estimate of x and τ in iteration (k−1). Let Fᵢ*(τ) and Gᵢ*(τ) be the first-order approximations of Fᵢ(τ) and Gᵢ(τ), respectively. Fᵢ*(τ) and Gᵢ*(τ) are then:

$$\begin{matrix}{F}_{i}^{*} ( τ ) = {F}_{i} ( {τ}^{( k - 1 )} ) + {\sum }_{j} ( {τ}_{j} - {τ}_{j}^{( k - 1 )} ) \times \frac{\partial }{\partial {τ}_{j}} {F}_{i} ( {τ}^{( k - 1 )} ) & ( 8 ) \\ {G}_{i}^{*} ( τ ) = {G}_{i} ( {τ}^{( k - 1 )} ) + {\sum }_{j} ( {τ}_{j} - {τ}_{j}^{( k - 1 )} ) \times \frac{\partial }{\partial {τ}_{j}} {G}_{i} ( {τ}^{( k - 1 )} ) & ( 9 )\end{matrix}$$

In the interest of brevity, the details on how to compute all the partial derivatives above have been omitted.

Substituting F(τ) and G(τ) with F*(τ) and G*(τ) in (NLP), one can obtain the following linear program:

$$maximize {\sum }_{d} {x}_{d} \\ subject to \{ \begin{matrix}{R}_{i} x \leq {F}_{i}^{*} ( τ ) & ∀ i \\ {G}_{i}^{*} ( τ ) \leq 0 & ∀ i \\ 0 \leq {x}_{d} \leq {x}_{d}^{*} & ∀ d \\ 0 \leq {τ}_{i} \leq 1 & ∀ i\end{matrix} \qquad ( {LP}_{k} )$$

One can then derive x^{(k)} and τ^{(k)} by solving the linear program (LPₖ). The optimal solution to (LPₖ), however, cannot be directly used because the LP is only an approximation to the original NLP. The resulting solution may not satisfy the constraints in the original NLP. To ensure x^{(k)} satisfies NLP, a simple line search can be applied to find a point on the line between x^{(k-1)} and x^{(k)} that is feasible. During the line search, the distance between x^{(k)} and x^{(k-1)} shrinks exponentially fast. Since the feasibility of x^{(k-1)} can be guaranteed, a feasible solution can be quickly found. In the evaluation of embodiments described herein, shrinkage ratio can be set to α=0.5. Finally, to better deal with numerical imprecision in the feasibility test, x^{(k)} can be scaled down by 1% at the end of each iteration (Line 9 in FIG. 6).

Since the problem of embodiments described herein is NLP, one cannot guarantee a global optimal solution. To improve the quality of the final solution, multiple starting points can be used. An all-zero starting points (i.e., all flows are inactive) can be included. To favor flows that are more likely to achieve higher throughput, one can also add (Nᵢₙᵢₜ−1) starting points, each with only a single active flow. Specifically, for each d=1, . . . , n, the largest x_{d}^{init}≦x_{d}* can be found such that it is feasible for flow d to send at rate x_{d}^{init} while all other flows are inactive. This can be done efficiently using the subroutine get_max_scaling_factor (see Section 4.2). The (Nᵢₙᵢₜ−1) flows with the largest x_{d}^{init} can then be selected, their rates can be reduced by a constant factor (by default) so that they are not too close to the boundary of the feasible solution space, and the resulted traffic assignments can be included as the starting points of embodiments described herein. In the experiments of embodiments described herein, Nᵢₙᵢₜ=4 starting points have been used. However, even a single all-zero starting point often yields good performance.

### 4.4 Practical Aspects of Optimization Strategy

Certain practical aspects of the optimization strategy of embodiments described herein are now discussed. According to one embodiment, the algorithms described herein can be implemented at a central location, such as in Tesseract (See H. Yan, D. A. Maltz, T. S. E. Ng, H. Gogineni, and H. Zhang, “Tesseract: A 4d network control plane,” In Proc. of NSDI, April 2007), or in a fully distributed manner. The distribution is similar to that in link-state protocols such as OSPF, in which all nodes implement the same algorithm, over the same data, and thus arrive at consistent solutions. Apart from topology information, distributing the algorithms of embodiments described herein also need demand estimates for various flows.

Another aspect that is related distributed implementation is the computational requirements of the approach of embodiments described herein. An exact quantification is a subject of ongoing work, but in the experiments described herein it has not been found to be a problem. In the unoptimized implementation described herein, rate computations are practical for online optimization. For instance, in the experiments described herein, it takes roughly three seconds to optimize ten flows in 25-node topologies.

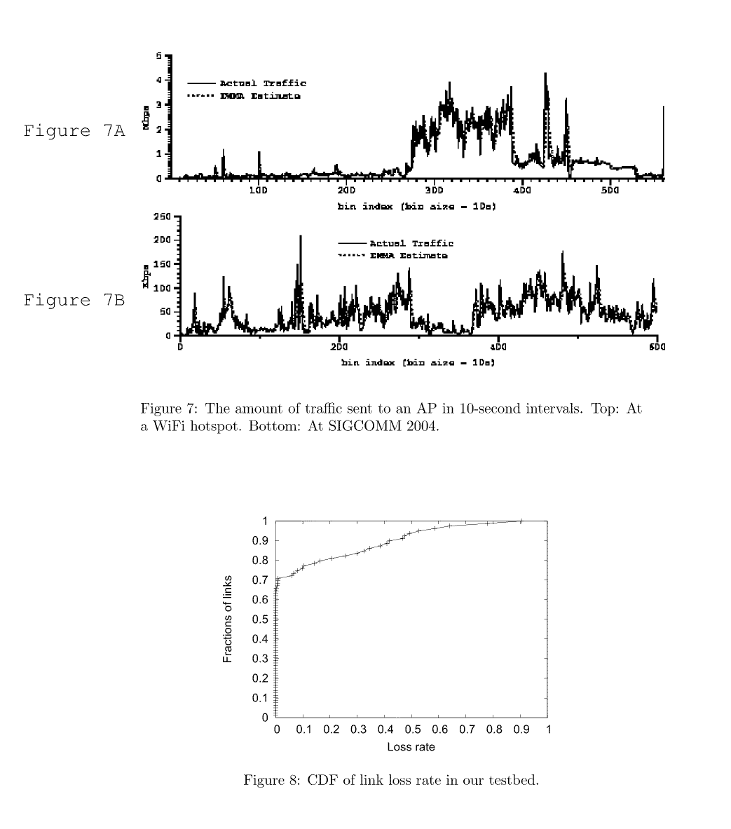

Finally, the methods of embodiments described herein can use flow demands as inputs for optimization. It is proposed that nodes base their estimates on recent history. Such a strategy is effective only if there is temporal stability in flow demands. While wireless meshes are not significantly deployed yet to settle this question with certainty, insight into this issue can be gained by studying wireless usage in two different environments—at a WiFi hotspot in Seattle and at the SIGCOMM 2004 conference (See R. Mahajan, M. Rodrig, D. Wetherall, and J. Zahorjan, “Analyzing the mac-level behavior of wireless networks,” In Proc. of SIGCOMM, 2006). FIG. 7 shows for 10-second windows, the actual traffic sent to an AP and the traffic predicted by EWMA (α=0.5) over history. One can see that traffic exhibits a high degree of temporal stability and EWMA predicts future traffic fairly accurately. What visually appears as sharp peaks and valleys in traffic are in fact composed of multiple time intervals, compressed so that one can show a two-hour period. The average traffic volume is 723.5 Kbps for the hotspot trace and 43.77 Kbps for the SIGCOMM trace. The mean absolute error (MAE), defined as mean(|Estimated−Actual|), is 200 Kbps for the hotspot trace and 15 Kbps for the SIGCOMM trace. Rate-limiting would actually even out those spikes if there is not enough capacity in the network. Suppose the APs that are measured were nodes in a city-wide wireless mesh, aggregating traffic from similar clients and sending it to a nearby gateway on the multi-hop mesh backhaul. Then, by extrapolating from these environments, one can judge that the nodes would be able to obtain reasonable estimates of their demands.

### 5. Evaluation of Methodology:

The accuracy of the approach of embodiments described herein can be evaluated using extensive testbed and simulation experiments. The former provides a setting with real-world complexities. The latter provides for conducting a broader range of experiments as well as varying parameters such as topology that one cannot control for the testbed.

The empirical results can be divided across three sections. In Section 6, the accuracy of the model of embodiments described herein is evaluated. In Section 7, the degree to which the model of embodiments described herein can improve performance for both goals, maximizing fairness and maximizing total throughput is evaluated. Fairness is quantified using the classic Jain's fairness index, which is defined as (τxᵢ)²/(n×Σxᵢ²) for demands x₁ . . . xₙ. In Section 8, it is shown that it is rate-limiting that is critical to network performance. Exactly how the routes are chosen is less important.

In the first two sections, ETX is used as the routing protocol. ETX selects the path that minimizes the total number of expected transmissions from a source to its destination (See D. D. Couto, D. Aguayo, J. Bicket, and R. Morris, “A high-throughput path metric for multi-hop wireless routing,” In Proc. of ACM MOBICOM, September 2003 (Couto et al.)).

### 5.1 Strawman: Conflict Graph Model

The approach of embodiments described herein is compared to one based on the conflict graph (CG) model of interference (See Jain et al.). The use of CG model has not been proposed in practical settings, but it provides an interesting comparison point in the evaluation.

The CG-based model assumes that packet transmissions at individual nodes can be finely controlled. It represents wireless links as conflict vertices and draws a conflict edge between two conflict vertices if and only if the corresponding wireless links interfere. Based on the definition, it is clear that links corresponding to conflict vertices in a clique in the conflict graph cannot be active simultaneously. Therefore, an upper bound of optimal wireless throughput can be computed by solving a linear program (LP) which specifies the goal of maximizing the total traffic delivered to the destination while satisfying flow conservation and clique constraints.

This formulation can be applied to derive the rate limits that maximize the total throughput. When applied to different route selection schemes, one can enforce traffic to follow the selected routes by adding the following linear constraints. For each Demand d and each Link e, T_{d,e}≦Capₑ×z_{d,e}, where T_{d,e} is the amount of traffic successfully routed for demand don link e, Capₑ is the capacity of link e, and z_{d,e}=1 if e is used to route demand d and 0 otherwise.

To maximize fairness, a similar formulation can be used. The main difference is that one can change the objective to maximizing the total throughput across all the flows and the portions of their demands that are achieved. This can be expressed as

$${\sum }_{d} {\sum }_{r ( e ) = dest ( d )} {T}_{d , e} + λα {\sum }_{d} {x}_{d} ,$$

where r(e) is the receiver of Link e, dest(d) is destination of Demand d, x_{d} is traffic demand, α is the minimum proportion of its demand that can be achieved, and λ controls the relative importance of these two objectives. In addition, the constraints can be added to ensure that each flow receives throughput no less than α×x_{d} (i.e., for each Demand d,

$${\sum }_{r ( e ) = dest ( d )} {T}_{d , e} \geq α \times {x}_{d} ) .$$

The evaluation uses λ=100 to significantly favor the solution with high fairness when maximizing fairness.

### 5.2 Simulation Experiments

The simulations described herein are based on QualNet v3.9.5. 802.11a with a fixed bit rate of 6 Mbps and free-space model of signal propagation is used, which provides a communication range of 230 meters. The interference range of 253 meters.

Traffic is generated using both TCP and UDP and two types of application demands are considered: (i) saturated demands, in which sources always have traffic to send; and (ii) random demands, in which the demand of a source is picked randomly from a uniform distribution between 0 and the maximum link load. The number of flows is varied from 1 through 20 where each flow is between a unique sender-receiver pair.

Two kinds of topologies are considered: 5×5 grid topologies and 25-node random topologies. Both occupy a 750×750 m² area. One can also study other network densities and find that the results are qualitatively similar. So they have been omitted in the interest of brevity.

For each scenario, 10 random trials are conducted. In each trial, flow sources and destinations are picked randomly. For random traffic demands and random topologies, each trial also randomly generates the demands and the topology.

The performance is evaluated with and without RTS/CTS. When RTS/CTS is enabled, RTS threshold is set to 100 bytes so that (small) TCP ACKs do not incur RTS/CTS overhead. In order for TCP to be robust to high link loss rates, TCP NewReno is used and the MAC-level short and long retry counts are set to 16. This is the largest maximum retry count allowed in madwifi-old driver, which is used in the testbed described herein.

Since several routing metrics (e.g., ETX (See Couto et al.) and MIC (See Y. Yang, J. Wang, and R. Kravets, “Designing routing metrics for mesh networks,” In IEEE Workshop on Wireless Mesh Networks (WiMesh), September 2005 (Yang et al.)) are designed for wireless networks with lossy links, the QualNet simulator is extended to generate directional inherent packet losses. In the evaluation described herein, bit-error-rate (BER) of links are randomly assigned such that the data packet loss rates are uniformly distributed between 0 and 80%. As wireless link loss rates depend on frame sizes, the evaluation considers both small and large frames. They have respective application payload sizes of 106 bytes and 1024 bytes. The broadcast probes used to measure link quality for routing are also 106 bytes, as in Couto et al.

### 5.3 Testbed Experiments

The testbed of one embodiment consists of 19 nodes located inside an office building. Each node runs Linux and is equipped with a NetGear WAG511 NIC. 802.11a with a fixed bit rate of 6 Mbps is run. No other 802.11a users are considered in the building. The lowest transmission power for the nodes to increase the network diameter is used. In this setting, the diameter is measured to be 7 hops, though routing paths may be longer. Other settings are consistent with the simulations.

The routing protocols are implemented using click (See Click, http://pdos.csail.mit.edu/click/). Nuttcp (See nuttcp, ftp://ftp.lcp.nrl.navy.mil/pub/nuttcp/) is used to generate and measure UDP and TCP throughput. To rate limit flows, nuttcp is allowed to generate application traffic at the specified limit. Without rate limit, each source generates application traffic as per its demand. 1-16 flows are experimented with.

As is common (See Couto et al., R. Draves, J. Padhye, and B. Zill, “Routing in multi-radio, multi-hop wireless mesh networks,” In Proc. of ACM MOBICOM, September-October 2004 (Draves et al.), and Yang et al.), link quality is measured using broadcast probes. FIG. 8 shows CDF of link loss rate in the testbed described herein. Links exceeding 90% loss rates are pruned in the route selection described herein.

### 6. Model Validation:

Below it can be shown that the model of embodiments described herein is accurate in a range of settings.

### Methodology

A good interference model should closely approximate achievable throughput given traffic demands as input, which implies that: (i) the throughput estimate should be achievable in the network, i.e., the model should not over-predict throughput; and (ii) the network should not be capable of delivering more throughput, i.e., the model should not under-predict. It is straightforward to evaluate for over-prediction—instantiate the estimated throughput to the network and check if the actual throughput comes close.

Evaluating under-prediction is more tricky. One technique is to increase the load on the network beyond what the model estimates and check how often that leads to higher network throughput. However, given multiple flows, there are numerous ways to increase network load. The experiments described herein use a simple uniform scaling approach that increases each flow throughput by the same factor. Scaling factors of 1.1, 1.2, and 1.5, which correspond to increasing load by 10%, 20%, and 50% are used.

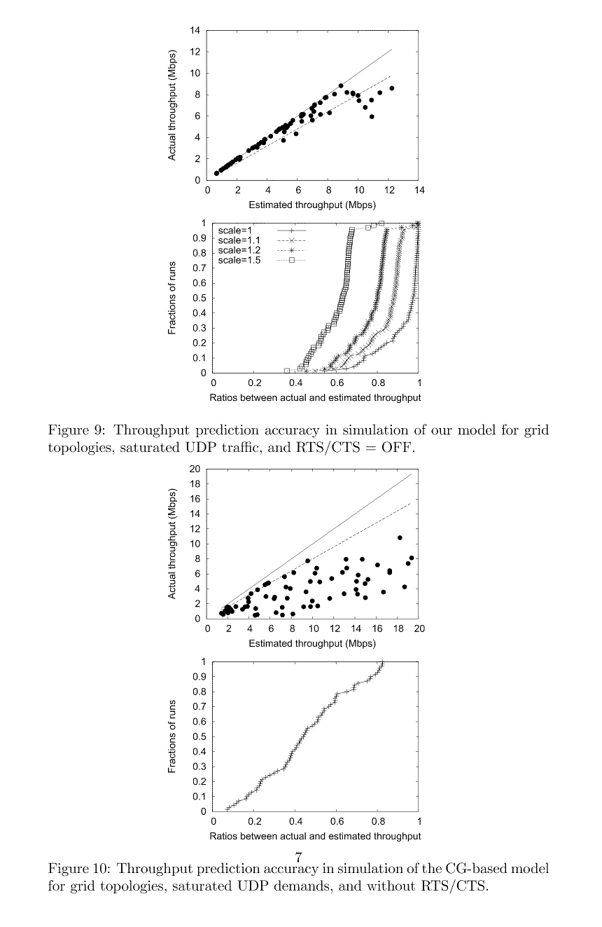

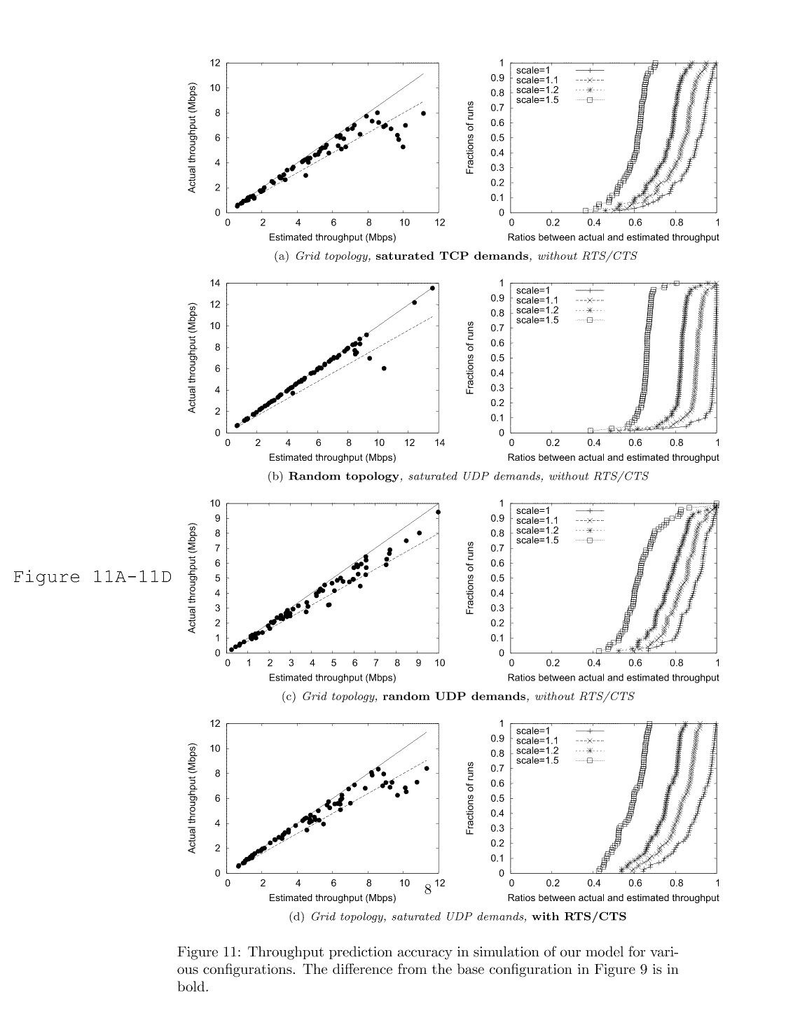

FIG. 9 shows the format in which results are presented in this section. To evaluate under-prediction, the left graph shows a scatter plot of actual and estimated throughput. The two lines on the scatter plot correspond to y=x and y=0.8x. They help judge the accuracy of the model visually. There will be no points above y=x as the network can never achieve more throughput than what is instantiated. The points below y=0.8x correspond to instances where the actual throughput is less than 80% of what is predicted by the model of embodiments described herein. The right graph is a CDF of the ratio of actual and estimated throughput, before and after scaling. The y-value of the point where a scaled curve reaches x=1 represents the fraction of cases where the model of embodiments described herein under-predicted by at least the scaling factor. The figures aggregate results across all flow counts that are generated. These counts vary between 1-20 in simulations and 1-16 in the testbed experiments.

In the experiments below, a data packet payload of 1024 bytes are used, as well as ETX to select routes. Qualitatively similar results can be found for smaller payloads (not shown) and other routing schemes (Section 8).

### 6.1 Simulation Experiments

FIG. 9 shows the accuracy of predicting the throughput in a grid topology with saturated UDP demands and without RTS/CTS. One can see from the scatter plot that the vast majority of the points lie between the lines, which implies that network throughput is over-predicted by more than 20% in very few cases. From the scale=1 CDF on the right, one can see that there are fewer than 15% such cases. Meanwhile, the worst-case overestimate is under 50%. A major cause for these over-predictions is that the model of embodiments described herein assumes pairwise interference. The model over-predicts when neither two senders interfere with a link alone but their total noise collectively interferes with the link.

The scaled CDFs show that the model of embodiments described herein does not under-predict either in this configuration. In almost all cases, the network is unable to achieve demands that have been scaled by even 10%.

For the same configuration, FIG. 10 shows the accuracy of the CG-based model. Clearly, this model vastly over-predicts what the network can achieve, because of the assumptions it makes about the ability of the nodes to finely coordinate their transmissions. From the CDFs, one can see the network achieves less than half of the predicted throughput in half of the cases. Thus, modeling 802.11 DCF, as the model of embodiments described herein does, is key to accurate predictions of network throughput. Interestingly, the inaccuracy of the CG-based model also hints at the performance cost of the CSMA-based 802.11 MAC under heavy load.

FIG. 11 shows that the model of embodiments described herein is robust across a wide range of other simulated configurations. For TCP traffic, it overestimates throughput by more than 20% in fewer than 20% of the cases. This accuracy is less than that for UDP because TCP creates bursty traffic and losses, which are not currently modeled in the model of embodiments described herein. However, as for UDP, the network's TCP throughput is never under-predicted even by 10%.

The remaining graphs in the figure show that the accuracy of the model of embodiments described herein is high even when one switches from grid to random topologies, or from saturated demands to randomly assigned demands, or from not using RTS/CTS to using it.

### 6.2 Testbed Experiments

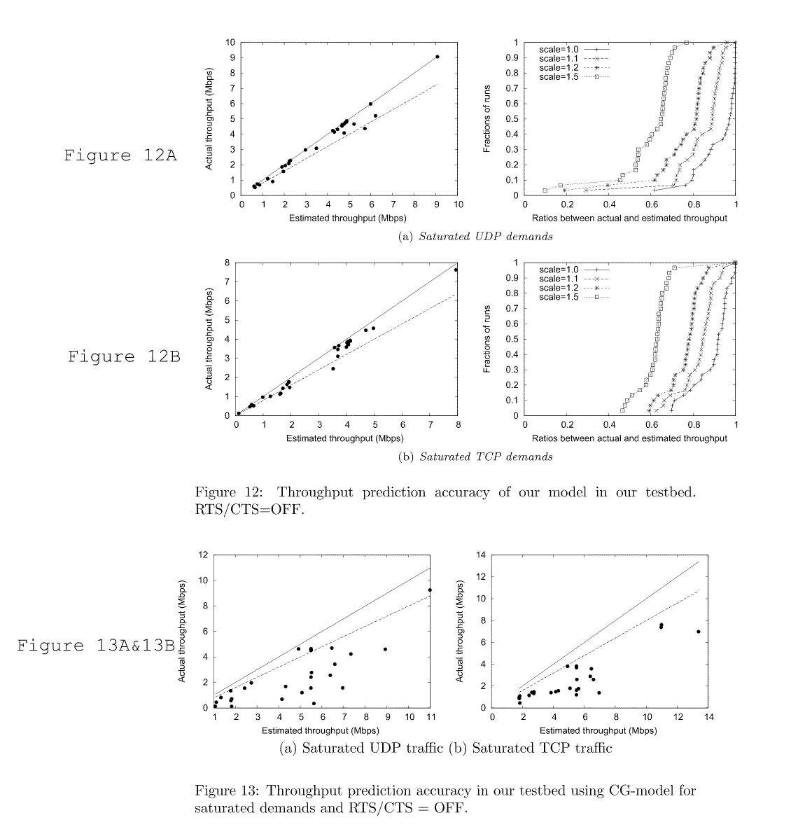

FIG. 12 shows that the model of embodiments described herein is fairly accurate in the more realistic testbed setting as well. For UDP, only in 10% of the cases is throughput over-predicted by more than 20%. For TCP, this over-prediction occurs for 20% of the cases, which is similar to that in simulation. The worst-case over-prediction is less than 40% for both TCP and UDP. Meanwhile, as in simulation, the model of embodiments described herein does not under-predict either. For both TCP and UDP, the network is unable to achieve demands that have been scaled by even 10%.

FIG. 13 shows the throughput prediction accuracy using CG-model. One can see that, as in simulation, the CG-model consistently over-estimates the achievable rates. Almost all the points are outside the cone formed by y=x and y=0.8x, which indicates that in most cases its estimated demands are not achievable within 80%.

### 7. Performance Optimization:

Can the accuracy of the model of embodiments described herein in predicting the throughout supported by the network be harnessed to improve performance, using the methods outlined above? This question is answered in this section by first considering fairness maximization and then throughput maximization. Results with no rate limiting, as it happens today, are compared with CG-based rate limiting.

### 7.1 Maximizing Fairness

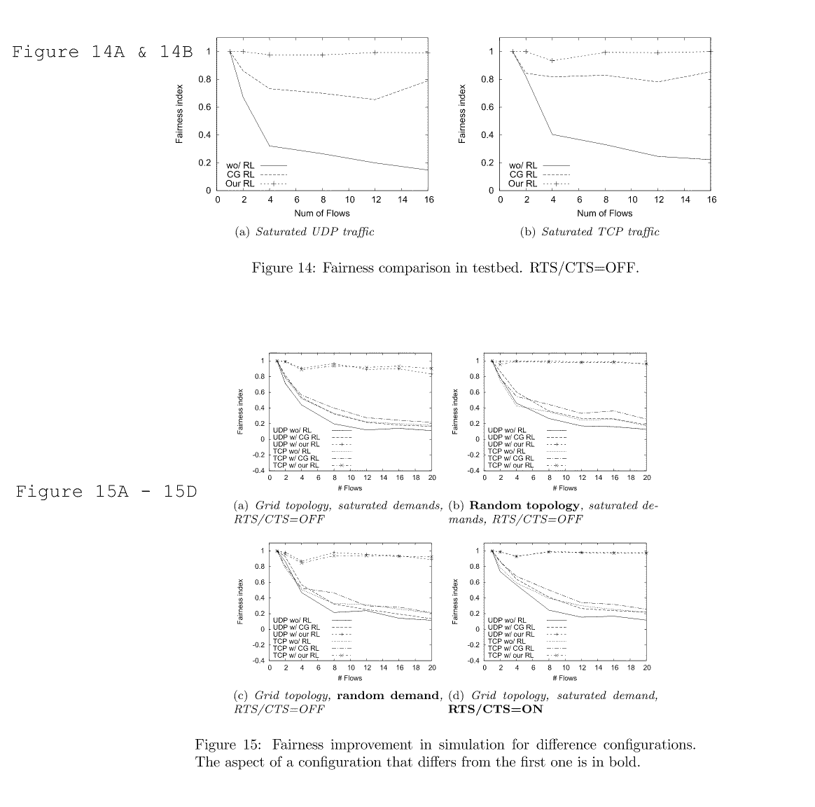

FIG. 14 shows the fairness index for TCP and UDP traffic in the testbed of embodiments described herein. One can see that the fairness index with the algorithm of embodiments described herein is remarkably close to 1 for both kinds of traffic and across all offered loads. Without rate limiting, fairness degrades quickly as load increases. Even with the CG-based rate limiting, fairness is substantially lower than with the rate limiting.

FIG. 15 shows the fairness provided by the model-driven approach of embodiments described herein holds in a range of simulated configurations, for both TCP and UDP traffic, including grid and random topologies, with saturated or random demand models, and with and without RTS/CTS.

### 7.2 Maximizing Total Throughput

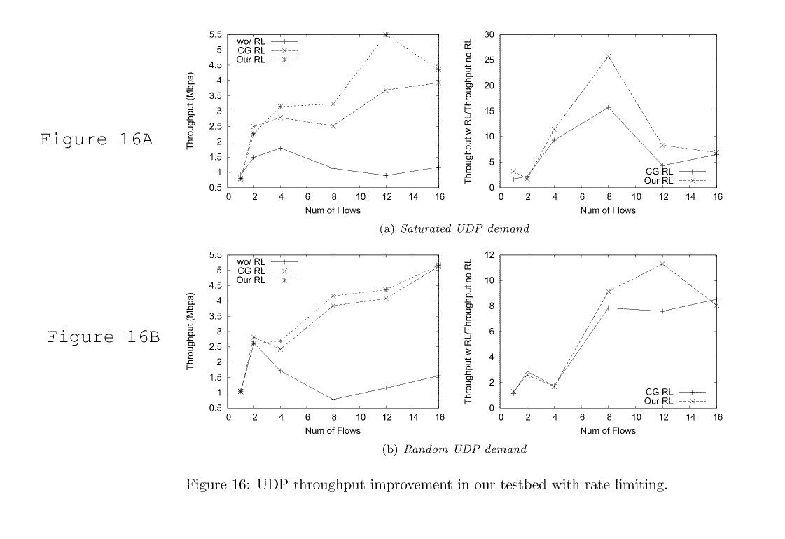

The performance objective of maximizing total throughput is now considered. FIG. 16A shows that the benefits of rate limiting for saturated UDP traffic in the testbed described herein are significant. The graph on the left plots the average total throughput, and the graph on the right plots the average normalized throughput (i.e., the throughput under rate limit normalized by the throughput under no rate limit). In terms of absolute throughput, UDP traffic experiences over 100% improvement; in terms of normalized throughput, the average improvement ranges from 100% to 2400%. The larger improvement in the latter suggests that rate limiting is especially beneficial to the flows that experience low throughput under no rate limiting. Like the model of embodiments described herein, the CG-based model is able to identify interference-related bottlenecks and impose rate limits. Therefore it helps boost network throughput. However, because the CG-based model significantly over-predicts throughput (Section 6), the loss rate in the network is much higher and the throughput is consistently lower. FIG. 16B shows the benefit of rate limiting extends to random UDP demands.

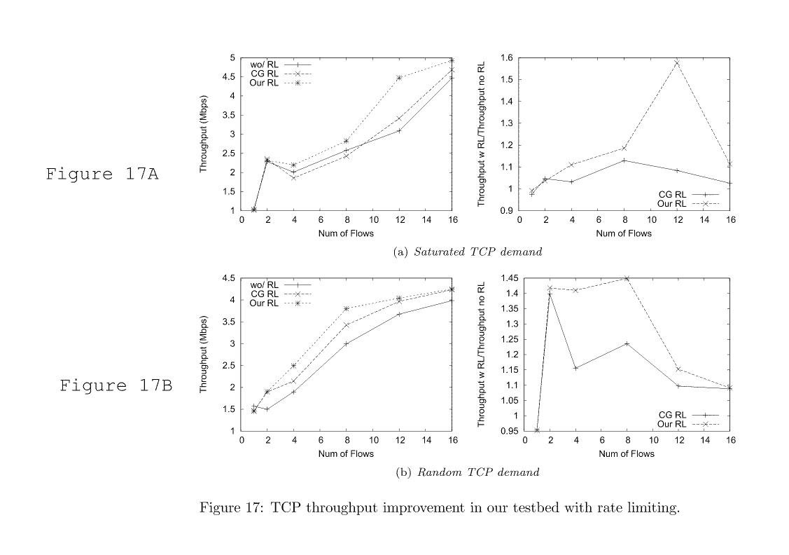

FIG. 17 shows that the gain from rate limiting saturated and random TCP flows is a more modest 10-50%. This lower improvement for TCP is expected given that infinitely long flows that react well to congestion are experimented with, thus minimizing interference-related losses. However, rate limiting will likely provide substantial benefits when TCP traffic is composed of many short transfers, as is common for Web transactions, because an aggregate of short TCP flows is significantly less responsive to losses than long TCP flows.

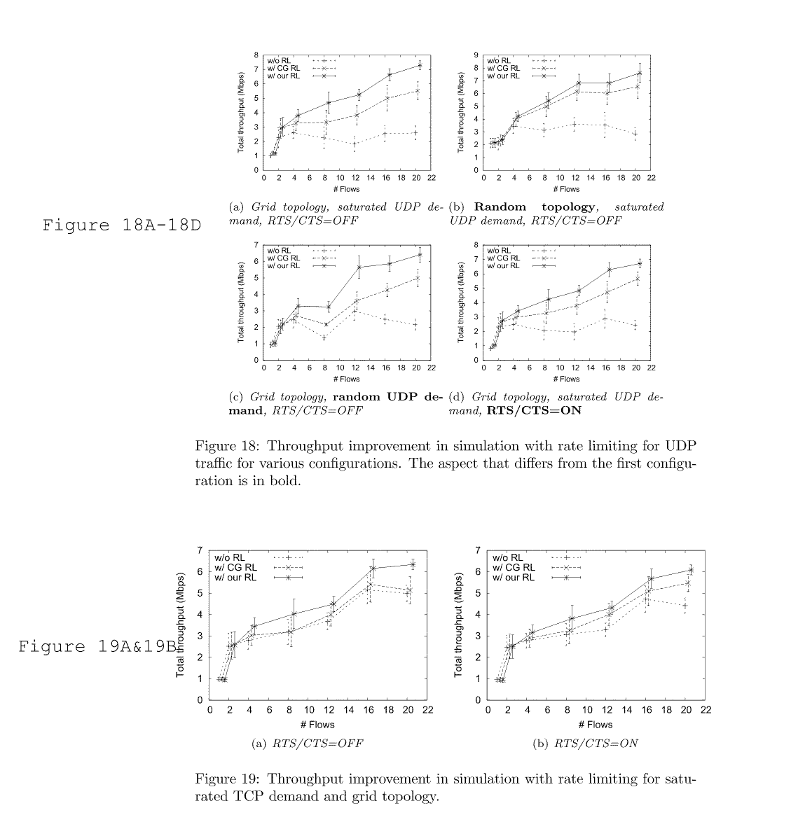

FIG. 18 shows the network throughput improvement for various simulated configurations with UDP traffic. The error bars denote standard deviation. Results consistent with the testbed across all configurations can be seen.

FIG. 19 shows the effectiveness of rate limiting for TCP traffic in simulated configurations with and without RTS/CTS. One can see, as with the testbed, the benefit of rate limiting tends to increase with more flows. Its benefit increases to 20-40% when the number of flows reaches 20. In general, rate limiting helps TCP traffic less than UDP traffic.

### 8. The Role of Routing:

All the results above are based on routing paths chosen by the ETX protocol. In this section, it can be shown that, surprisingly, the choice of the exact routing protocol makes little difference in the experiments described herein. Three other protocols are studied and all four are found to behave similarly. What seems to matter most is whether flows are being rate-limited.

The three other protocols studied are the following: (1) HOP selects a path with minimum hop-count; (2) MIC (See Yang et al.) scales ETX values of a link by multiplying it by the sum of the neighbors of the two end points. It then selects a path with the minimum scaled ETX value; (3) CG selects the routes by casting the routing problem to a maximum flow problem augmented with interference constraints derived by a conflict graph (See Jain et al.). These routes are close to optimal if nodes can finely coordinate transmissions.

Only the goal of maximizing throughput is considered, but similar results can be obtained for maximizing fairness.

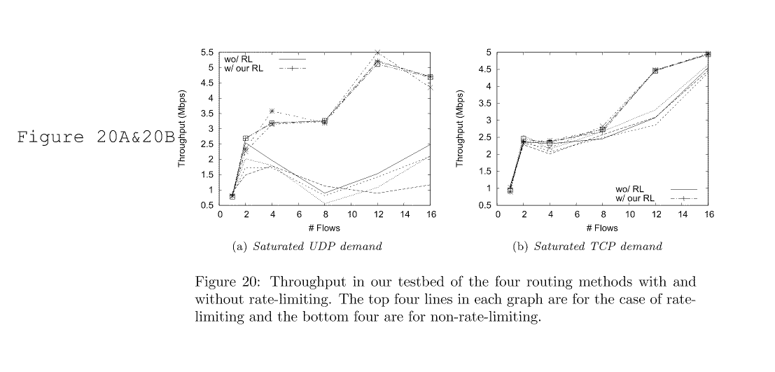

FIG. 20 shows UDP and TCP performance under different routing schemes. The bottom four curves are the performance of different routing schemes under no rate limiting, and the top four curves show the results using rate limiting based on the model of embodiments described herein, with the objective of maximizing total throughput. One can see that the routing schemes are almost indistinguishable. Rate-limiting does matter, however. For each scheme, rate-limiting using the model of embodiments described herein provides 50-400% gain for UDP and 10-45% for TCP.

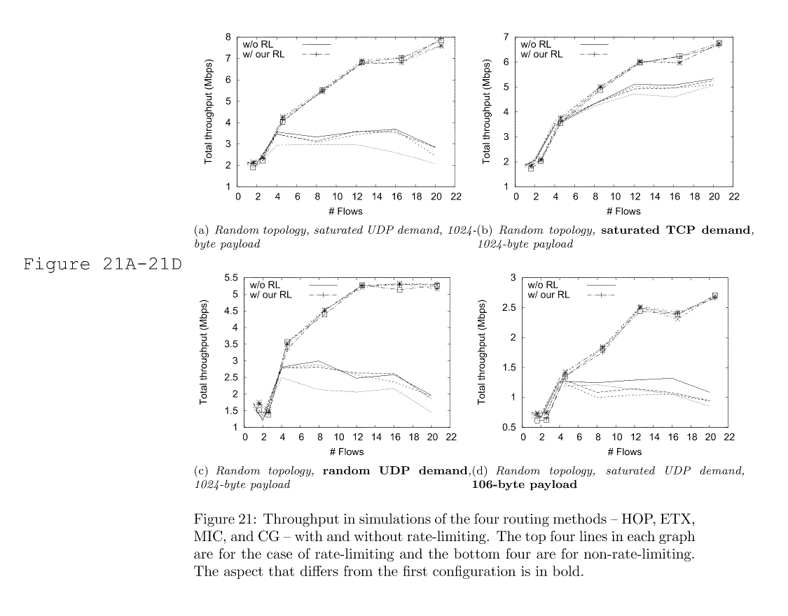

In FIG. 21, one can see the same effect in other simulated configurations. Routing does not seem to matter whether there is TCP or UDP traffic, saturated or random demands, big or small payloads. To rule out differences in probe packet size and payload size, which may cause ETX to select the wrong path, probe-sized payload packets are also considered. As FIG. 21D shows, that does not make a significant difference either.

These routing protocols differ in how they account for interference, but they all have their shortcomings on that front (See Y. Li, L. Qiu, Y. Zhang, R. Mahajan, Z. Zhong, G. Deshpande, and E. Rozner, “Effects of interference on throughput of wireless mesh networks: Pathologies and a preliminary solution,” In Proc. of HotNets-VI, November 2007 (Li et al.) for more details). For example, the ETX metric is determined by packet loss rates at receivers; so it only captures receiver-side interference but fails to capture sender-side interference that stops nodes from transmitting. Moreover, the characteristics of probing traffic and data traffic can be quite different in terms of, for instance, volume, packet sizes and generation pattern, which makes the two observe different loss rates. Therefore, the ETX metric does not accurately predict the actual performance experienced by data traffic. The MIC metric is based on ETX, so it has similar issues. The CG-based routing assumes perfect scheduling and tends to select longer detours, which perform well under perfect scheduling but not under 802.11.

What can be shown is that once interference has been properly managed through rate-limiting, the small variations in routing paths produced by these protocols have relatively low impact on total network throughput. As noted above, the methods for rate-limiting described herein are agnostic to the choice of the underlying routing protocol. They can thus work with whichever routing method that provides better performance in the given setting.

### 9. Related Work:

The work described herein builds on a large body of prior work that can be broadly classified into three categories: (i) interference modeling; (ii) rate control and scheduling; and (iii) routing.

### Interference Modeling

There is a rich body of work on modeling wireless interference. One class of works focuses on asymptotic performance bounds. The seminal work by Gupta and Kumar analyzed the capacity of a wireless network under certain traffic patterns and topologies (See Gupta et al.). Other researchers have since extended this work to other traffic patterns (See J. Li, C. Blake, D. S. J. D. Couto, H. I. Lee, and R. Morris, “Capacity of ad hoc wireless networks,” In Proc. of MOBICOM, July 2001), mobility (See M. Grossglauser and D. N.C. Tse, “Mobility increases the capacity of ad hoc wireless networks,” In Proc. of IEEE INFOCOM, April 2001), and network coding (See M. Gastpar and M. Vetterli, “On the capacity of wireless networks: the relay case,” In Proc. of IEEE INFOCOM, June 2002). While these works lend useful insight into the performance of wireless networks in the limit, their models are abstract by necessity and cannot be used to model any specific real network.

The second class of works studies wireless performance for a given network topology and traffic demands but does not model the MAC and instead assumes that packet transmissions can be finely scheduled across links (See Jain et al.). As shown in Section 6, these models significantly over-estimate the performance of 802.11 networks.

The third class of works model the performance of 802.11 DCF MAC. Most models in this class target scenarios where every node is within communication range of the others (See Bianchi, Kumar et al., Gao et al, and Garetto et al.) or where traffic demands are restricted (e.g., a single flow (See Garetto et al. and Gao et al.) or two flows (See Reis et al.) or to a single neighbor (See M. Garetto, T. Salonidis, and E. Knightly, “Modeling per-flow throughput and capturing starvation in CSMA multi-hop wireless networks,” In Proc. of IEEE Infocom, March 2006). In addition, all the above models, except Reis et al. assume binary interference. T. Salonidis, M. Garetto, A. Saha, and E. Knightly, “Identifying high throughput paths in 802.11 mesh networks: a model-based approach,” In ICNP, October 2007 is one of the few that supports non-binary interference. But it requires detailed measurement of the current network condition, such as channel busy probability and packet loss rates (including collision rate). So it has limited prediction power—it can only estimate the effect of introducing one new flow to the network. Two recent models (See Qiu et al., and A. Kashyap, S. Das, and S. Ganguly, “A measurement-based approach to modeling link capacity in 802.11-based wireless networks,” In Proc. of ACM MOBICOM, September 2007) are more general but even they target only one-hop demands and are also too expensive to be used for optimization.

In contrast, embodiments described herein tackle the most general case of multi-hop topologies and end-to-end flows, but even so the model of embodiments described herein is lightweight enough to be directly used for optimization.

### Rate Control and Scheduling

The importance of rate control and scheduling has been well recognized. Some existing works (See L. Tassiulas and A. Ephremidesm, “Stability properties of constrained queueing systems and scheduling policies for maximum throughput in multihop radio networks,” In IEEE Transactions on Automatic Control, December 1992; X. Lin and N. B. Shroff, “Joint rate control and scheduling in multihop wireless networks,” In Proc. of IEEE Conference on Decision and Control, 2004; and A. Eryilmaz and R. Srikant, “Fair resource allocation in wireless networks using queue-length based scheduling and congestion control,” In Proc. of IEEE INFOCOM, March 2005) propose joint optimization of rate control and scheduling. Different from these works, the approach of embodiments described herein works with existing 802.11 MAC scheduling. IFRC enables fair rate control for sensor networks in which all nodes send traffic towards one or more sinks (See S. Rangwala, R. Gummadi, R. Govindan, and K. Psounis, “Interference-aware fair rate control in wireless sensor networks,” In ACM SIGCOMM, September 2006). It is specific to the tree topologies and sensor network workload. Prior work shows preliminary evidence on the importance of rate limiting and the possibility of using conflict graphs for that purpose (See Li et al.). According to embodiments described herein, a more accurate model is developed so that predictable performance optimization can be performed.

### Routing

Many routing protocols for wireless networks follow a least-cost-path model but differ in the methods for estimating link cost. Some use hop count (See C. E. Perkins and E. M. Royer, “Ad hoc on-demand distance vector routing,” In Proc. of the 2nd IEEE Workshop on Mobile Computing Systems and Applications, February 1999; and D. B. Johnson, D. A. Maltz, and J. Broch, “DSR: The dynamic source routing protocol for multihop wireless ad hoc networks,” In Ad Hoc Networking, 2001), some use expected number of transmissions (ETX) (See Couto et al.), while others use ETX scaled by factors such as modulation or the number of neighbors (See Draves et al., Yang et al. and A. P. Subramanian, M. M. Buddhikot, and S. Miller, “Interference aware routing in multi-radio wireless mesh networks,” In IEEE Workshop on Wireless Mesh Networks (WiMesh), September 2006). These sequence of metrics are motivated by improving the performance of routing. Embodiments described herein show, however, that rate-limiting flows can be key to predictable and high performance—severe performance degradation can occur in its absence—and the differences in routing metrics appear to matter less.

### Overall System and Electronic Device:

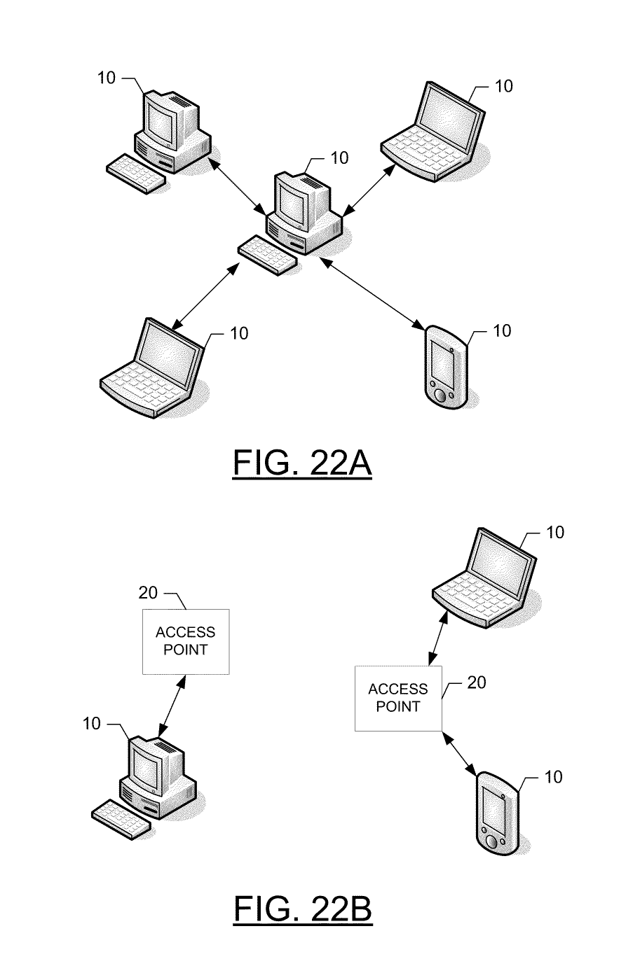

Referring to FIGS. 22A and 22B, embodiments of the present invention may, for example, be implemented in association with a multi-hop wireless network, such as a Carrier Sense Multiple Access (CDMA) wireless network (FIG. 22A) and/or a single-hop wireless local area network (LAN) (FIG. 22B). As shown, each network can include a plurality of wireless network devices 10 in communication directly and/or via one or more access points 20, wherein the access points 20 can be connected using a backend wireline network. According to embodiments described herein, these devices 10 may comprise personal computers (PCs), laptops, meshboxes, personal digital assistants (PDAs), sensor nodes, and/or the like, capable of supporting communication in accordance with, for example, the IEEE 802.11 standard.

According to embodiments described herein, any of the wireless network devices 10 in the multi-hop wireless network of FIG. 22A can be configured to perform the modeling and optimization techniques/algorithms described above. In one embodiment, one wireless network device 10 may perform the computations and then transmit the results to the remaining devices of the network. Alternatively, all of the devices 10 in the network may perform the same computation, using the same input and, therefore, arrive at the same results. According to another embodiment, one or more of the access points 20 of the single-hop wireless LAN of FIG. 22B can be configured to perform the modeling and optimization techniques/algorithms described above.

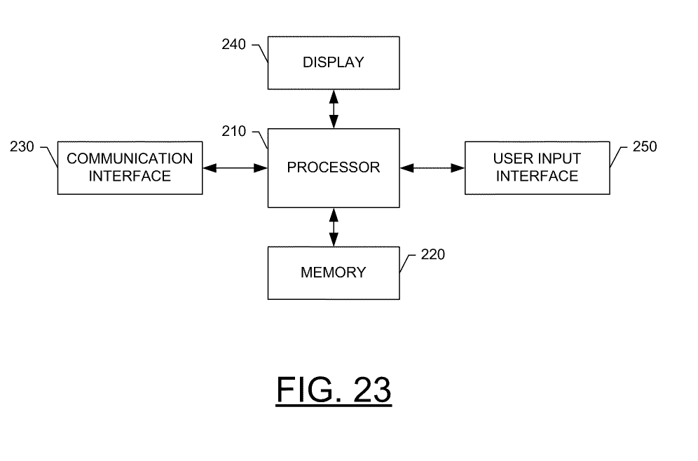

Referring now to FIG. 23, a block diagram of an entity capable of operating as one of the wireless network devices 10 and/or access points 20 is shown in accordance with one embodiment of the present invention. The entity capable of operating as one of the wireless network devices 10 and/or access points 20 includes various means for performing one or more functions in accordance with embodiments of the present invention, including those more particularly shown and described herein. It should be understood, however, that one or more of the entities may include alternative means for performing one or more like functions, without departing from the spirit and scope of the present invention. As shown, the entity capable of operating as one of the wireless network devices 10 and/or access points 20 can generally include means, such as a processor 210 for performing or controlling the various functions of the entity.

For example, according to one embodiment the processor 210 may be configured to use the model of embodiments described herein in order to perform any or all of the optimization algorithms described above for the purpose of computing rate limits for flows in order to achieve specified performance objectives.

In one embodiment, the processor is in communication with or includes memory 220, such as volatile and/or non-volatile memory that stores content, data or the like. For example, the memory 220 may store content transmitted from, and/or received by, the entity. Also for example, the memory 220 may store software applications, instructions or the like for the processor to perform steps associated with operation of the entity in accordance with embodiments of the present invention. In particular, the memory 220 may store software applications, instructions or the like for the processor to perform the operations described above for using the model of embodiments described herein in order to perform one or more optimization algorithms.

In addition to the memory 220, the processor 210 can also be connected to at least one interface or other means for displaying, transmitting and/or receiving data, content or the like. In this regard, the interface(s) can include at least one communication interface 230 or other means for transmitting and/or receiving data, content or the like, as well as at least one user interface that can include a display 240 and/or a user input interface 250. The user input interface, in turn, can comprise any of a number of devices allowing the entity to receive data from a user, such as a keypad, a touch display, a joystick or other input device.

While FIG. 23 illustrates one example of a wireless network device 10 and/or access point 20 that could be used in accordance with embodiments described herein, as one of ordinary skill in the art will recognize in light of this disclosure, the wireless network device 10 and/or access point 20 need not include all of the components shown in FIG. 23 and may include additional components now shown. For example, the wireless network device 10 and/or access point 20 of embodiments described herein may not include either or both of the display 240 or user interface 250.

### CONCLUSION

The work described herein demonstrates the feasibility of predictable performance optimization for wireless networks, thus making the task of managing and optimizing them as predictable as that for wired networks. A foundation of the approach of embodiments described herein is a new model that captures, for example, interference, traffic, and MAC-induced dependencies in the network using only a small set of constraints. The model of one embodiment is realistic enough to handle real-world complexities such as hidden terminals, non-uniform demands, and non-binary interference, and yet it is lightweight enough to drive network optimization.

Evaluations of the methodology described herein using a testbed and simulations showed that it can be very effective. Across a range of topology and traffic configurations, the methodology was able to accurately approximate the throughput that the network yielded. It rarely under-predicted, and for 80% of the cases, it estimated within 20% of the actual throughput. When maximizing fairness using the methods of embodiments described herein, close to perfect fairness amongst flows for both UDP and TCP traffic can be achieved. When maximizing throughput, it can be found that the methods of embodiments described herein can improve network throughput by 100-200% for UDP-based traffic and 10-50% for TCP-based traffic.

As described above and as will be appreciated by one skilled in the art, embodiments of the present invention may be configured as a system, method or apparatus. Accordingly, embodiments of the present invention may be comprised of various means including entirely of hardware, entirely of software, or any combination of software and hardware. Furthermore, embodiments of the present invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method comprising:
developing a model of a wireless network that captures complex interference, traffic and MAC-induced dependencies in the wireless network; and
using the model to compute one or more rate limits for an individual flow within the wireless network for achieving a specified performance objective.

2. A method of inventive concept 1, wherein developing a model further comprises:
defining a relationship between throughput and packet loss rate;
defining a relationship between packet loss rate and transmission probability; and
bounding the transmission probability by a function of the packet loss rate.

3. The method of inventive concept 2, wherein the relationship between throughput and packet loss rate is defined by
$${g}_{i} = \frac{{EP}_{i} \times {τ}_{i} \times ( 1 - {p}_{i} )}{{μ}_{i}} ,$$
wherein gᵢ represents the throughput for Link i, EPᵢ represents the expected payload transmission time at Link i, τᵢ represents the probability for Link i to start a packet transmission during a variable-length slot (VLS) transmission, pᵢ represents the loss probability for such a packet transmission, and μᵢ represents the expected duration of a VLS at Link i.

4. The method of inventive concept 2, wherein the relationship between packet loss rate and transmission probably is defined by
$${p}_{i} = 1 - ( 1 - {L}_{i}^{data} ) \times ( 1 - {L}_{i}^{ack} ) \times {\prod }_{j \neq i} [ ( 1 - {S}_{ij} {τ}_{j} ) \times {( 1 - {θ}_{j} )}^{{A}_{ij}} ] ,$$
wherein pᵢ represents the packet loss rate, Lᵢ^{data} represents the inherent loss rate of DATA on Link i, Lᵢ^{ack} represents the inherent loss rate of ACK on Link i, Sᵢⱼ represents the probability a packet on Link i will get lost due to collision with a packet on Link j, τᵢ represents the probability for Link j to start transmitting at the same time as Link i, μᵢ represents the expected duration of a variable-length slot (VLS) at Link i,
$${θ}_{j} = \frac{{τ}_{j}}{{μ}_{j}}$$
represents the probability for Link j to start transmitting at a random time instant, Aᵢⱼ represents the asynchronous collision loss exponent.

5. The method of inventive concept 2, wherein developing a model further comprises:
defining a relationship between an expected variable-length slot (VLS) duration and transmission probability.

6. The method of inventive concept 5, wherein the relationship between an expected VLS duration and transmission probability is defined by
$${μ}_{i} = {T}_{slot} + {\sum }_{j} [ ( {W}_{ij} - {T}_{slot} ) \times {τ}_{j} ] ,$$
wherein μᵢ represents the expected VLS duration, Tₛₗₒₜ represents a regular time slot, Wᵢⱼ(i≠j) represents the expected amount of time for Link i to wait due to carrier-sense for Link j to complete a transmission, Wᵢᵢ represents the expected amount of time for Link i to complete a transmission, and τⱼ represents the transmission probability.

7. The method of inventive concept 1, wherein the specified performance objective is selected from a group comprising a maximum fairness and a maximum total network throughput.

8. The method of inventive concept 1, wherein using the model to compute one or more rate limits further comprises performing an iterative process to compute respective rate limits.

9. The method of inventive concept 1, wherein the wireless network comprises an IEEE 802.11-based multi-hop network.

10. The method of inventive concept 1, wherein the wireless network comprises a Carrier Sense Multiple Access (CSMA) wireless network.

11. The method of inventive concept 1, wherein using the model to compute one or more rate limits for an individual flow further comprises using the model to test whether a set of link throughputs (gᵢ's) associated with a corresponding set of Links (i's) is feasible.

12. The method of inventive concept 11, wherein using the model to test whether a set of link throughputs (gᵢ's) associated with a corresponding set of Links (i's) is achievable further comprises performing an iterative procedure to jointly estimate a transmission probability (τᵢ) and loss rate (pᵢ) associated with each Link (i) in the set of links.

13. The method of inventive concept 12, wherein performing the iterative procedure further comprises:
initializing the transmission probability (τᵢ) and loss rate (pᵢ) associated with each Link (i) in the set of links to zero;
estimating the transmission probability (τᵢ) and loss rate (pᵢ) associated with each Link (i) in the set of links based on the following algorithm:

| | [symbol] Input: a vector of link thoughput [symbol] gᵢ [symbol] ; | |
|---|---|---|
| | [symbol] Output: whether [symbol] gᵢ [symbol] is feasible | |
| 1. | initialization: feasible = 0, τᵢ = 0, pᵢ = 0 (i = 1,2, . . .,n) | |
| | // iterative model evaluation (MaxIter = 20 by default) | |
| 2 | for iter = 1 to MaxIter | |
| 3. | ${θ}_{i} = \frac{{g}_{i}}{{EP}_{i} \times ( 1 - {p}_{i} )} i = 1 , 2 , … , n$ | |
| 4. | [symbol] τᵢ [symbol] = estimate_tau_from_theta( [symbol] θᵢ [symbol] ) | |
| 5. | [symbol] pᵢ [symbol] = compute_packet_loss_rates( [symbol] τᵢ [symbol] , [symbol] θᵢ [symbol] ) | // according to Eq. 3 |
| 6. | $if any i whose ( {τ}_{i} > \frac{2}{2 + CW ( {p}_{i} )} )$ | |
|---|---|---|
| 7. | feasible = 0: break | // early stop: infeasible |
| 8. | endif | |
| 9. | ${g}_{i}^{′} = \frac{{τ}_{i} \times ( 1 - {p}_{i} ) \times {EP}_{i}}{{τ}_{slot} + {\sum }_{j} [ ( {W}_{ij} - {τ}_{slot} ) \times {τ}_{j}}$ | |
| 10. | if (max i{\|gᵢ − g′ᵢ\|} < TOL) | // convergence test (TOL = 0.01 by default) |
| 11. | feasible = 1: break | // early stop: feasible |
| | |
|---|---|
| 12. | end if |
| 13. | end for |
| 14. | return feasible |

wherein θᵢ represents the probability that Link i will start sending at a random slot time, τᵢ represents the probability that Link i will transmit in a random variable-length slot (VLS), pᵢ represents the loss rate of Link i, gᵢ represents the throughput for Link i, EPᵢ represents the expected payload transmission time at Link i, CW represents the contention window size under loss rate pᵢ, Tₛₗₒₜ represents a regular time slot, and Wᵢⱼ (i≠j) represents the expected amount of time for Link i to wait due to carrier-sense for Link j to complete a transmission;
iteratively updating the transmission probability (τᵢ) and loss rate (pᵢ) associated with each Link (i) in the set of links based on the estimation; and
repeating the estimating and iteratively updating until the number of iterations reaches a threshold, the throughput values (gᵢ's) no longer change substantially, or a feasibility constraint is violated.

14. The method of inventive concept 11, wherein using the model to compute one or more rate limits for an individual flow further comprises using the model to achieve weighted max-min fair rate allocations based at least in part on the feasibility of the set of link throughputs (gᵢ's).

15. The method of claim 14, wherein using the model to achieve weighted max-min fair rate allocations further comprises performing the following algorithm:

| | [symbol] Input: routing matrix R = [R_{id}]_{n×m}, end-to end demand x* = [symbol] x*_{d} [symbol] (d ∈ [1, m]) | |
|---|---|---|
| | [symbol] Output: weighted max-min fair rate allocation: x = [symbol] x_{d} [symbol] | |
| 1. | initialization: unsatSet = {l, . . . , m}; x_{d} = 0 | |
| 2. | while (unsatSet ≠ 0) | |
| | // try to scale up the unsaturated demands x^{unsat} as much as possible | |
| 3. | ${x}_{d}^{unsat} = \{ \begin{matrix}{x}_{d}^{*} & if d ∈ unsatSet \\ 0 & otherwise\end{matrix} ( d = 1 , … , m )$ | |
| | // find largest scale ∈ [0, 1] for R(x + scale × x^{unsat}) to remain feasible | |
| 4. | scale = get_max_scaling_factor(Rx^{unsat}, Rx) | |
| 5. | z = x + scale × x^{unsat} | |
| | // find the set of demands that become saturated | |
| 6. | if (scale > 1 − ε) | // ε = 10⁻⁴ by default |
| 7. | x = z; break | // all unsaturated demands can be satisfied |
| 8. | end if | |
|---|---|---|
| 9. | for each d ε unsatSet | |
| 10. | y = z; y_{d} = (1 + ε) × y_{d} | |
| 11. | feasible = test_link_throughput_feasibility(Ry) | |
| 12. | if (not feasible) | |
| 13. | x_{d} = z_{d}; unsatSet = unsatSet − {d} | // d has become saturated |
| | |
|---|---|
| 14. | end if |
| 15. | end for |
| 16. | end while |
| 17. | return x = [symbol] x_{d} [symbol] |

wherein R=[R_{id}]_{n×m} represents the routing matrix, R_{id} represents the fraction of Flow d that traverses link i, x*=<x_{d}*> represents the end-to-end demand, R·x represents the vector link loads, unsatSet represents the set of flows whose demands are unsaturated, x_{d}^{unstat} represents the unsaturated traffic demands, x represents the weighted max-min fair rate allocation, and feasible=1 if it is determined that the set of traffic demands can be supported by the networks otherwise feasible=0.

16. The method of claim 11, wherein using the model to compute one or more rate limits for an individual flow further comprises using the model to optimize maximum total throughput of the wireless network.

17. The method of claim 16, wherein using the model to optimize maximum total throughput of the wireless network further comprises performing the following algorithm:

| | |
|---|---|
| 1. | initialization: x_{d}⁽⁰⁾ = 0, τᵢ⁽⁰⁾ = 0, for ∀d∀i |
| 2. | for k = 1 to KMAX |
| 3. | let x^{opt} and τ^{opt} be the optimal solution to the linear program (LPₖ) |
| 4. | x^{(k)} = x^{opt} |
| 5. | repeat // ensure solution feasibility |
| 6. | x^{(k)} = x^{(k-1)} + α × (x^{(k)} − x^{(k-1)}) |
| 7. | feasible = test_link_throughput_feasibility(Rx^{(k)}) |
| 8. | until (feasible = true) |
| 9. | x^{(k)} = 0.99 × x^{(k)} |
| 10. | end for |
| 11. | return x^{(k)} |

wherein x^{(k)} represents the estimate of rate limit x in iteration k, R×x^{k} is the link load, and τ^{(k)} represents the estimate of the probability that Link i will transmit in a random variable-length slot (VLS) in iteration k.
